(19) United States
(12) Patent Application Publication
(10) Pub. No.: US 2010/0019084 A1
(43) Pub. Date: Jan. 28, 2010

(54) Aerospace manufacturing system

(76) Inventor: David B. Sisk, Brownsboro, AL (US)

Correspondence Address: Giaccherini, Post Office Box 1146, Carmel Valley, CA, 93924, US

(21) Appl. No.: 12/220,709

(22) Filed: Jul. 25, 2008

(51) Int. Cl. B64D 47/00

(52) U.S. Cl. 244/1 R

(57) ABSTRACT

An Aerospace Manufacturing System is disclosed, which comprises methods and apparatus for reducing the manufacturing costs in an aerospace product. In one embodiment, this method is accomplished by designing the aerospace product to use non-aerospace industry components and by maximizing the use of said plurality of readily commercially available, non-aerospace industry components. These commercially available, non-aerospace components are sometimes referred to by the term “commercial off the shelf” or “COTS” products.

### INTRODUCTION

The title of this Original, Non-Provisional Patent Application is Aerospace Manufacturing System. The Applicant is David B. Sisk of 600 Sunburst Circle, Brownsboro, Ala. 35741. The Applicant is a Citizen of the United States of America.

### FEDERALLY SPONSORED RESEARCH OR DEVELOPMENT

None.

### FIELD OF THE INVENTION

The present invention pertains to methods and apparatus for an aerospace manufacturing system. More particularly, one preferred embodiment of the invention incorporates non-aerospace and out-sourced products and manufacturing methods to produce aerospace products, such as satellites, space vehicles and launchers.

### BACKGROUND OF THE INVENTION

### I. Aerospace Industry Background & Differentiation

The U.S. aerospace industry currently comprises about 1,500 companies, with a combined annual revenue of approximately $125 billion. Conventional aerospace systems and products, such as satellites, space vehicles and launchers, are generally manufactured according to strict “aerospace standards.” Many aerospace systems are meticulously produced “one at a time,” as opposed to using the mass production methods that are employed to produce “commercial products.” As a general rule, commercial products comprise the more familiar goods that are commonly available in the retail marketplace, such as cars, kitchen appliances, televisions and other household items.

The aerospace industry researches, designs, manufactures, operates, and maintains vehicles moving through air and space. According to the Bureau of Labor Statistics:

“Aerospace manufacturing is an industry that produces ‘aircraft, guided missiles, space vehicles, aircraft engines, propulsion units, and related parts.’”

The Aerospace Industry Manufacturing Sector is characterized by very high personnel costs, very high infrastructure and manufacturing facility investments, very complex, risky, and costly technologies, very high risk and cyclical markets, and very high quality requirements for products and components, due to often catastrophic consequences of system failures. Aerospace vehicles are generally highly complex, performance-optimized, weight-minimized systems that typically employ exotic materials and advanced technologies. Aerospace product design, development, manufacturing, integration, and testing generally require a very large labor force that is very specialized, very highly trained, and very expensive. Production workers in the U.S. aerospace industry, for example, earn higher pay than the average for all industries. According to the U.S. Department of Labor Bureau of Labor Statistics (BLS), weekly earnings for production workers averaged $1,019 in aerospace product parts manufacturing in 2004, compared with an average of $659 across all manufacturing industries. BLS attributes this nearly more than 50% surcharge in average earnings, in part, to the “high levels of skill required by the industry and the need to motivate workers to concentrate on maintaining high quality standards in their work.”

Aerospace manufacturing processes, especially those for spacecraft and space launch vehicles, have changed relatively little over the past few decades, and are characterized by extensive work and material documentation, hand-crafted components in very small production runs, and very specialized and expensive tooling and facilities such as clean rooms. Many aerospace industry manufacturing facilities, themselves very costly to build, operate, and maintain, are underutilized and operate at significantly less than full capacity. Aerospace products generally achieve reliability through inspection, test, manufacturing rework, and rigorous procedural controls. For many aerospace vehicle components, production economies of scale are often very low relative to their non-aerospace, functional equivalents. This is particularly true for space launch vehicles which typically use different components even across multiple stages and which are often produced in very limited quantities.

Very low production economies of scale, coupled with the very high number of specialized parts employed by many aerospace systems and the relatively small number of aerospace component suppliers, has made sustainability of many aerospace systems problematic. Sustainability issues can be especially daunting in the launch vehicle and missile industry sectors where critical vendors have been forced to exit the market due to lack of demand or the high costs of maintaining a very expensive production line for relatively small volume sales of their highly specialized aerospace system components. The U.S. Department of Defense (DoD) has instituted several programs such as the Manufacturing Technology Program to address aerospace system sustainability by helping maintain the critical industrial base for certain DoD systems. Prominent use of relatively high volume, stable, non-aerospace, commercial-off-the-shelf, or “COTS” commodity hardware can dramatically improve aerospace system sustainability by minimizing parts obsolescence and the likelihood of a critical vendor exiting the market.

Manufacturing and assembling of complete units in the aerospace industry typically involves several tiers of contractors, as follows:
First Tier—Prime Contractors—Design, assemble, and integrate or manufacture complete, stand-alone aerospace vehicles. Often referred to as OEMs (Original Equipment Manufacturers).
Second Tier—Subcontractors—Design, assemble, and integrate or manufacture major subsystems of aerospace vehicles (e.g., complete rocket engine).
Third Tier—Subcontractors—Produce subsystem components (e.g., rocket engine nozzles, avionics computers).
Fourth Tier—Subcontractors—Specialize in the production of particular component parts (e.g., rocket engine propellant feed system valve).
Fifth Tier—Subcontractors—Manufacture hardware (e.g., fasteners) and provide raw materials (e.g., titanium).

Sustainability of aerospace vehicles due to parts obsolescence and lack of demand is often very difficult. For the case of space transportation systems, the U.S. Congressional report, “The Lowest Tiers of the Space Transportation Industrial Base,” notes that many lower-tier manufacturing firms have difficulty remaining in business and that new suppliers are required within five years for 35-40% of critical subsystems and components used in DoD launch vehicles. (Office of Technology Assessment, United States Congress, “The Lowest Tiers of the Space Transportation Industrial Base,” August 1995, Washington, D.C., U.S. Government Printing Office, OTA-BP-ISS-161, page 13.) The report also states that many space launch vehicle subsystems and components are produced by only one or two suppliers, and that very low production runs and long set-up times force high-cost production, exacerbating sustainability challenges. The report authors interviewed executives of lower tier aerospace firms who indicated that federal procurement regulatory burdens flowed down from prime contractors effectively taxed their space transportation vehicle products, making them noncompetitive in other commercial markets.

These factors contribute to make aerospace component and system manufacturing extremely expensive and difficult to sustain compared to the vast majority of non-aerospace industry commercial products. The cost per pound of military and commercial aircraft hardware, for example, often exceeds a thousand of dollars per pound, and for space launch vehicles and spacecraft, many thousands of dollars per pound. This contrasts sharply to the automotive manufacturing where hardware costs are typically measured in tens of dollars per pound.

While aerospace manufacturing has changed little over the past few decades, there has been a quiet revolution in most non-aerospace manufacturing sectors. The non-aerospace commercial industry in the United States that has survived and excelled in a global competitive marketplace with intense foreign competition with far lower labor rates has generally been forced to adopt very rigorous quality and reliability standard practices and management techniques such as total quality management, six sigma, and lean production to provide highly flexible, low cost, high quality manufacturing. The U.S. automotive industry, with its impressive quality gains and cost reduction in just the last fifteen years or so, is a prime example. Today, many non-aerospace commercial industry sectors achieve very high levels of manufacturing quality and reliability that exceed the minimum required for many aerospace applications through fundamentally different mechanisms than the aerospace industry—the consistency of assembly line production and rigorous process controls. With the proper design, aerospace products can leverage the low cost, high quality manufacturing processes used in non-aerospace industries to create aerospace products far more cheaply than the aerospace industry is currently able to accomplish. Such a design requires design simplicity, standardization, unusually high performance margin, and adoption of commercial-off-the-shelf (COTS) components to an unprecedented degree over current aerospace art. Properly done, using non-aerospace commercial industry to manufacture, integrate, and test the aerospace product, in concert with extensive COTS component use, can reduce manufacturing costs to a fraction of those of the aerospace industry. These cost savings can be amplified by designing the aerospace product explicitly for assembly-line production and to take advantage of rate effects and large economies of scale. Using existing non-aerospace commercial infrastructure with excess capacity eliminates the need for dedicated and typically underutilized aerospace manufacturing facilities, further reducing costs.

Aerospace design requirements are usually more stringent than non-aerospace design requirements due to applied environment (for example, acceleration, radiation, material out-gassing in the vacuum of space); low design margin and high performance optimization due to flight performance needs for extreme lightweight systems; and severity of catastrophic failure (for example, airline or Space Shuttle crash, non-recoverable and hence unfixable malfunction of satellites often costing hundreds of millions of dollars).

These unique requirements, combined with the need for high quality, have been strong forces in evolving the aerospace industry to its current state of being highly differentiated from all non-aerospace industry, and have resulted in the aerospace industry having developed its own unique management, manufacturing, and quality assurance processes, as reflected by domestic and international aerospace industry standards.

This Background Section presents information that illustrates how the aerospace industry differentiates from non-aerospace industries via product content and international standards, and defines and compares parts and components that are manufactured in the aerospace and non-aerospace industries.

### II. Typical Aerospace Product Content

FIG. 1 is a graphical representation A of the relative typical content of an aerospace product produced using conventional aerospace manufacturing methods. The triangle B represents the total product content of a typical aerospace product. The area of each segment of the triangle represents a category of product content, as measured by part counts. The largest segment of the triangle C, which rises from the base, almost to the apex, represents custom designed components fabricated by aerospace industry manufacturing materials and processes. The other four areas of the triangle, which together generally represent less than five to ten percent of the total area, comprise:
Aerospace industry COTS components D;
Custom designed components fabricated by non-aerospace industry manufacturing materials and processes E;
Modified non-aerospace industry COTS components F; and
Unaltered non-aerospace industry COTS components G.
   The acronym “COTS” stands for “commercial off-the-shelf,” and generally refers to parts or components that are readily available in the commercial marketplace. This relative typical content of an aerospace product holds true for almost all aerospace systems including military and large commercial satellites, space launch vehicles, and military and commercial aircraft.

A rare exception to this relative typical content of an aerospace product can be found in some small satellites (microsats, nanosats, and picosats) in which significant aerospace COTS hardware exists today and is often utilized by government laboratories, universities, and businesses to construct relatively small, inexpensive satellites. In some of these cases, the vast majority of the satellite is composed of custom designed components fabricated by aerospace industry manufacturing materials and processes and aerospace industry COTS components, and the top three areas of the triangle of FIG. 1—custom designed components fabricated via non-aerospace industry manufacturing materials and processes, modified non-aerospace industry COTS components, and unaltered non-aerospace industry COTS components—together generally represent less than five to ten percent of the total area.

### III. Example of Product Standards: Aerospace Versus Non-Aerospace ISO

In 1947, International Organization for Standardization was founded. ISO is a worldwide federation of national standards bodies from some 100 countries, with one standards body representing each member country. The American National Standards Institute (ANSI), for example, represents the United States. Member organizations collaborate in the development and promotion of international standards. Among the standards the ISO fosters is Open Systems Interconnection (OSI), a universal reference model for communication protocols.

The foremost aim of international standardization is to facilitate the exchange of goods and services through the elimination of technical barriers to trade. Three bodies are responsible for the planning, development and adoption of International Standards: ISO is responsible for all sectors excluding Electrotechnical, which is the responsibility of IEC (International Electrotechnical Committee), and most of the Telecommunications Technologies, which are largely the responsibility of ITU (International Telecommunication Union).

ISO is a legal association, the members of which are the National Standards Bodies (NSBs) of some 140 countries (organizations representing social and economic interests at the international level), supported by a Central Secretariat based in Geneva, Switzerland.

The principal deliverable of ISO is the International Standard. An International Standard embodies the essential principles of global openness and transparency, consensus and technical coherence. These are safeguarded through their development in an ISO Technical Committee (ISO/TC).

By default, the ISO Standards listing presents the complete listing of Published standards and Standards under development. The user chooses whether to access the listing By ICS (classified by subject in accordance with the International Classification for Standards) or By TC (sorted according to the ISO technical committee responsible for the preparation and/or maintenance of the standards).

### IV. ISO International Standards

Table One contains a list of ISO International Standards organized by ISO Classification:

TABLE ONE

| ICS | Field |
|---|---|
| 01 | Generalities. Terminology. Standardization. Documentation |
| 03 | Services. Company organization, management and quality. |
| | Administration. Transport. Sociology |
| 07 | Mathematics. Natural Sciences |
| 11 | Health care technology |
| 13 | Environment. Health protection. Safety |
| 17 | Metrology and measurement. Physical phenomena |
| 19 | Testing |
| | Analytical chemistry, see 71.040 |
| 21 | Mechanical systems and components for general use |
| 23 | Fluid systems and components for general use |
| | Measurement of fluid flow, see 17.120 |
| 25 | Manufacturing engineering |
| 27 | Energy and heat transfer engineering |
| 29 | Electrical engineering |
| 31 | Electronics |
| 33 | Telecommunications. Audio and video engineering |
| 35 | Information technology. Office machines |
| 37 | Image technology |
| 39 | Precision mechanics. Jewelery |
| 43 | Road vehicles engineering |
| 45 | Railway engineering |
| 47 | Shipbuilding and marine structures |
| 49 | Aircraft and space vehicle engineering |
| 53 | Materials handling equipment |
| 55 | Packaging and distribution of goods |
| 59 | Textile and leather technology |
| 61 | Clothing industry |
| 65 | Agriculture |
| 67 | Food technology |
| 71 | Chemical technology |
| 73 | Mining and minerals |
| 75 | Petroleum and related technologies |
| 77 | Metallurgy |
| 79 | Wood technology |
| 81 | Glass and ceramics industries |
| 83 | Rubber and plastic industries |
| 85 | Paper technology |
| 87 | Paint and colour industries |
| 91 | Construction materials and building |
| 93 | Civil engineering |
| 95 | Military engineering |
| 97 | Domestic and commercial equipment. Entertainment. Sports |

Table One shows that ISO has created a set of international standards in Classification Number 49 for “Aircraft and space vehicle engineering.”

ISO has also created Technical Committees to administer these international standards. Table Two presents a list of Technical Committees, which includes TC20, a Technical Committee for “Aircraft and Space Vehicles.”

TABLE TWO

| | |
|---|---|
| TC 1 | Screw threads |
| TC 2 | Fasteners |
| TC 4 | Rolling bearings |
| TC 5 | Ferrous metal pipes and metallic fittings |
| TC 6 | Paper, board and pulps |
| TC 8 | Ships and marine technology |
| TC 10 | Technical product documentation |
| TC 11 | Boilers and pressure vessels |
| TC 12 | Quantities, units, symbols, conversion factors |
| TC 14 | Shafts for machinery and accessories |
| TC 17 | Steel |
| TC 18 | Zinc and zinc alloys |
| TC 19 | Preferred numbers |
| TC 20 | Aircraft and space vehicles |
| TC 21 | Equipment for fire protection and fire fighting |
| TC 22 | Road vehicles |
| TC 23 | Tractors and machinery for agriculture and forestry |
| TC 24 | Sieves, sieving and other sizing methods |
| TC 25 | Cast irons and pig irons |
| TC 26 | Copper and copper alloys |
| TC 27 | Solid mineral fuels |
| TC 28 | Petroleum products and lubricants |
| TC 29 | Small tools |
| TC 30 | Measurement of fluid flow in closed conduits |
| TC 31 | Tyres, rims and valves |
| TC 33 | Refractories |
| TC 34 | Food products |
| TC 35 | Paints and varnishes |
| TC 36 | Cinematography |
| TC 37 | Terminology |
| TC 38 | Textiles |
| TC 39 | Machine tools |
| TC 41 | Pulleys and belts (including veebelts) |
| TC 42 | Photography |
| TC 43 | Acoustics |
| TC 44 | Welding and allied processes |
| TC 45 | Rubber and rubber products |
| TC 46 | Information and documentation |
| TC 47 | Chemistry |
| TC 48 | Laboratory equipment |
| TC 51 | Pallets |
| TC 52 | Light gauge metal containers |
| TC 54 | Essential oils |
| TC 58 | Gas cylinders |
| TC 59 | Building construction |
| TC 60 | Gears |
| TC 61 | Plastics |
| TC 63 | Glass containers |
| TC 67 | Materials, equipment and offshore structures for petroleum, |
| | petrochemical and natural gas industries |
| TC 68 | Financial services |
| TC 69 | Applications of statistical methods |
| TC 70 | Internal combustion engines |
| TC 71 | Concrete, reinforced concrete and pre-stressed concrete |
| TC 72 | Textile machinery and accessories |
| TC 74 | Cement and lime |
| TC 76 | Transfusion, infusion and injection equipment for medical and |
| | pharmaceutical use |
| TC 77 | Products in fibre reinforced cement |
| TC 79 | Light metals and their alloys |
| TC 81 | Common names for pesticides and other agrochemicals |
| TC 82 | Mining |
| TC 83 | Sports and recreational equipment |
| TC 84 | Devices for administration of medicinal products and |
| | intravascular catheters |
| TC 85 | Nuclear energy |
| TC 86 | Refrigeration and air-conditioning |
| TC 87 | Cork |
| TC 89 | Wood-based panels |
| TC 91 | Surface active agents |
| TC 92 | Fire safety |
| TC 93 | Starch (including derivatives and by-products) |
| TC 94 | Personal safety - Protective clothing and equipment |
| TC 96 | Cranes |
| TC 98 | Bases for design of structures |
| TC 100 | Chains and chain sprockets for power transmission |
| | and conveyors |
| TC 101 | Continuous mechanical handling equipment |
| TC 102 | Iron ore and direct reduced iron |
| TC 104 | Freight containers |
| TC 105 | Steel wire ropes |
| TC 106 | Dentistry |
| TC 107 | Metallic and other inorganic coatings |
| TC 108 | Mechanical vibration, shock and condition monitoring |
| TC 109 | Oil and gas burners |
| TC 110 | Industrial trucks |
| TC 111 | Round steel link chains, chain slings, components |
| | and accessories |
| TC 112 | Vacuum technology |
| TC 113 | Hydrometry |
| TC 114 | Horology |
| TC 115 | Pumps |
| TC 116 | Space heating appliances |
| TC 117 | Industrial fans |
| TC 118 | Compressors and pneumatic tools, machines and equipment |
| TC 119 | Powder metallurgy |
| TC 120 | Leather |
| TC 121 | Anaesthetic and respiratory equipment |
| TC 122 | Packaging |
| TC 123 | Plain bearings |
| TC 126 | Tobacco and tobacco products |
| TC 127 | Earth-moving machinery |
| TC 128 | Glass plant, pipeline and fittings |
| TC 129 | Aluminum ores |
| TC 130 | Graphic technology |
| TC 131 | Fluid power systems |
| TC 132 | Ferroalloys |
| TC 133 | Sizing systems and designations for clothes |
| TC 134 | Fertilizers and soil conditioners |
| TC 135 | Non-destructive testing |
| TC 136 | Furniture |
| TC 137 | Footwear sizing designations and marking systems |
| TC 138 | Plastics pipes, fittings and valves for the transport of fluids |
| TC 142 | Cleaning equipment for air and other gases |
| TC 144 | Air distribution and air diffusion |
| TC 145 | Graphical symbols |
| TC 146 | Air quality |
| TC 147 | Water quality |
| TC 148 | Sewing machines |
| TC 149 | Cycles |
| TC 150 | Implants for surgery |
| TC 152 | Gypsum, gypsum plasters and gypsum products |
| TC 153 | Valves |
| TC 154 | Processes, data elements and documents in |
| | commerce, industry and administration |
| TC 155 | Nickel and nickel alloys |
| TC 156 | Corrosion of metals and alloys |
| TC 157 | Mechanical contraceptives |
| TC 158 | Analysis of gases |
| TC 159 | Ergonomics |
| TC 160 | Glass in building |
| TC 161 | Control and protective devices for gas and oil burners |
| | and gas and oil burning appliances |
| TC 162 | Doors and windows |
| TC 163 | Thermal performance and energy use in the built environment |
| TC 164 | Mechanical testing of metals |
| TC 165 | Timber structures |
| TC 166 | Ceramic ware, glassware and glass ceramic ware in |
| | contact with food |
| TC 167 | Steel and aluminum structures |
| TC 168 | Prosthetics and orthotics |
| TC 170 | Surgical instruments |
| TC 171 | Document management applications |
| TC 172 | Optics and photonics |
| TC 173 | Assistive products for persons with disability |
| TC 174 | Jewelry |
| TC 175 | Fluorspar |
| TC 176 | Quality management and quality assurance |
| TC 177 | Caravans |
| TC 178 | Lifts, escalators and moving walks |
| TC 179 | Masonry |
| TC 180 | Solar energy |
| TC 181 | Safety of toys |
| TC 182 | Geotechnics |
| TC 183 | Copper, lead, zinc and nickel ores and concentrates |
| TC 184 | Industrial automation systems and integration |
| TC 185 | Safety devices for protection against excessive pressure |
| TC 186 | Cutlery and table and decorative metal hollow-ware |
| TC 188 | Small craft |
| TC 189 | Ceramic tile |
| TC 190 | Soil quality |
| TC 191 | Animal (mammal) traps |
| TC 192 | Gas turbines |
| TC 193 | Natural gas |
| TC 194 | Biological evaluation of medical devices |
| TC 195 | Building construction machinery and equipment |
| TC 196 | Natural stone |
| TC 197 | Hydrogen technologies |
| TC 198 | Sterilization of health care products |
| TC 199 | Safety of machinery |
| TC 201 | Surface chemical analysis |
| TC 202 | Microbeam analysis |
| TC 203 | Technical energy systems |
| TC 204 | Intelligent transport systems |
| TC 205 | Building environment design |
| TC 206 | Fine ceramics |
| TC 207 | Environmental management |
| TC 208 | Thermal turbines for industrial application (steam turbines, gas |
| | expansion turbines) |
| TC 209 | Cleanrooms and associated controlled environments |
| TC 210 | Quality management and corresponding general aspects |
| | for medical devices |
| TC 211 | Geographic information/Geomatics |
| TC 212 | Clinical laboratory testing and in vitro diagnostic test systems |
| TC 213 | Dimensional and geometrical product specifications |
| | and verification |
| TC 214 | Elevating work platforms |
| TC 215 | Health informatics |
| TC 216 | Footwear |
| TC 217 | Cosmetics |
| TC 218 | Timber |
| TC 219 | Floor coverings |
| TC 220 | Cryogenic vessels |
| TC 221 | Geosynthetics |
| TC 222 | Personal financial |
| TC 223 | Societal Security |
| TC 224 | Service activities relating to drinking water supply systems and |
| | wastewater systems - Quality criteria of the service and |
| | performance indicators |
| TC 225 | Market, opinion and social research |
| TC 226 | Materials for the production of primary aluminium |
| TC 227 | Springs |
| TC 228 | Tourism and related services |
| TC 229 | Nanotechnologies |
| TC 230 | Project Committee: Psychological assessment |
| TC 231 | Project Committee: Brand valuation |
| TC 232 | Learning services for non-formal education and training |
| TC 234 | Fisheries and aquaculture |
| TC 235 | Project Committee: Rating services |
| TC 236 | Project Committee: Project Management |
| TC 237 | Project committee: Exhibition terminology |
| TC 238 | Solid biofuels |
| TC 241 | Project Committee: Road-Traffic Safety Management System |

### V. Comparison of an Aerospace Industry Product Versus a Non-Aerospace Industry Product: A Bolt

Table Three presents a list of International Standards within the ISO ICS 49: Aircraft and Space Vehicle Engineering:

TABLE THREE

| | |
|---|---|
| 49.020 | Aircraft and space vehicles in general; Including aircraft performance, |
| | flight dynamics, etc. |
| 49.025 | Materials for aerospace construction |
| 49.030 | Fasteners for aerospace construction; Fasteners for general use see 21.060 |
| 49.035 | Components for aerospace construction; |
| 49.040 | Coatings and related processes used in aerospace industry Coatings for general |
| | use, see 25.220 |
| 49.045 | Structure and structure elements |
| 49.050 | Aerospace engines and propulsion systems; Including fuel systems |
| 49.060 | Aerospace electric equipment and systems; Including Avionics |
| 49.080 | Aerospace fluid systems and components |
| 49.090 | On-board equipment and instruments; Including navigation instruments |
| | and telecommunications equipment |
| 49.095 | Passenger and cabin equipment |
| 49.100 | Ground service and maintenance equipment |
| 49.120 | Cargo equipment; Air mode containers, pallets and nets, see 55.180.30 |
| 49.140 | Space systems and operations; Including space data and information |
| | transfer systems, and ground support equipment for launch site operations |

Section 49.030 pertains to: “Fasteners for aerospace construction; Fasteners for general use see 21.060” Table Four shows a list of sub-classifications within Section 49.030:

TABLE FOUR
49.030: Fasteners for aerospace construction

| ICS | Field |
|---|---|
| 49.030.01 | Fasteners in general |
| 49.030.10 | Screw threads; Screw threads for general use, see 21.040 |
| 49.030.20 | Bolts, screws, studs |
| 49.030.30 | Nuts |
| 49.030.40 | Pins, nails |
| 49.030.50 | Washers and other locking elements |
| 49.030.60 | Rivets |
| 49.030.99 | Other fasteners |

Sub-section 49.030.20 pertains to “Bolts, screws and studs.”

Table Five presents a list of twenty-two ISO Standards that concern aerospace bolts:

TABLE FIVE
Aerospace Bolts ISO Standards (49.030.20: Bolts, screws, studs - Filtered to show
bolts only)

| | |
|---|---|
| ISO/DIS 3185 | Aerospace - Bolts, normal bihexagonal head, normal shank, |
| | short- or medium-length MJ threads, metallic material, coated or uncoated, strength |
| | classes less than or equal to 1 100 MPa - Dimensions |
| ISO 3185:1993 | Aerospace - Bolts, normal bihexagonal head, normal shank, |
| | short or medium length MJ threads, metallic material, coated or uncoated, strength |
| | classes less than or equal to 1 100 MPa - Dimensions |
| ISO/DIS 3186 | Aerospace - Bolts, large bihexagonal head, normal shank, short- |
| | or medium-length MJ threads, metallic material, coated or uncoated, strength classes |
| | 1 250 MPa to 1 800 MPa - Dimensions |
| ISO 3186:1994 | Aerospace - Bolts, large bihexagonal head, normal shank, short |
| | or medium length MJ threads, metallic material, coated or uncoated, strength classes |
| | 1 250 MPa to 1 800 MPa - Dimensions |
| ISO 3193:1991 | Aerospace - Bolts, normal hexagonal head, normal shank, short |
| | or medium length MJ threads, metallic material, coated or uncoated, strength classes |
| | less than or equal to 1 100 MPa - Dimensions |
| ISO/DIS 3193 | Aerospace - Bolts, normal hexagonal head, normal shank, short- |
| | or medium-length MJ threads, metallic material, coated or uncoated, strength classes |
| | less than or equal to 1 100 MPa - Dimensions |
| ISO 3203:1993 | Aerospace - Bolts, normal bihexagonal head, normal or pitch |
| | diameter shank, long length MJ threads, metallic material, coated or uncoated, |
| | strength classes less than or equal to 1 100 MPa - Dimensions |
| ISO 5857:1988 | Aerospace - Alloy steel protruding head bolts with strength |
| | classification 1 250 MPa and MJ threads - Procurement specification |
| ISO/DIS 5857 | Aerospace - Bolts, with MJ threads, made of alloy steel, strength |
| | class 1 250 MPa - Procurement specification |
| ISO/DIS 7689 | Aerospace - Bolts, with MJ threads, made of alloy steel, strength |
| | class 1 100 MPa - Procurement specification |
| ISO 7689:1988 | Aerospace - Alloy steel bolts with strength classification 1 100 MPa |
| | and MJ threads - Procurement specification |
| ISO 7913:1994 | Aerospace - Bolts and screws, metric - Tolerances of form and |
| | position |
| ISO 7961:1994 | Aerospace - Bolts - Test methods |
| ISO/DIS 8168 | Aerospace - Bolts, with MJ threads, made of heat- and |
| | corrosion-resistant steel, strength class 1 100 MPa - Procurement specification |
| ISO 8168:1988 | Aerospace - Corrosion- and heat-resisting steel bolts with |
| | strength classification 1 100 MPa and MJ threads - Procurement specification |
| ISO 9152:1998 | Aerospace - Bolts, with MJ threads, in titanium alloys, strength |
| | class 1 100 MPa - Procurement specification |
| ISO 9154:1999 | Aerospace - Bolts, with MJ threads, made of heat-resistant |
| | nickel-based alloy, strength class 1 550 MPa - Procurement specification |
| ISO 9219:2002 | Aerospace - Bolts, thin hexagonal head, for pulleys, close |
| | tolerance shank, short thread, in alloy steel and cadmium plated or in titanium alloy |
| | and MoS2 lubricated or in corrosion-resistant steel and passivated - Dimensions and |
| | masses |
| ISO 9254:1993 | Aerospace - Bolt, normal spline head, normal or pitch diameter |
| | shank, long length MJ threads, metallic material, coated or uncoated, strength classes |
| | less than or equal to 1 100 MPa - Dimensions |
| ISO 9255:1993 | Aerospace - Bolts, normal spline head, normal shank, short or |
| | medium length MJ threads, metallic material, coated or uncoated, strength classes less |
| | than or equal to 1 100 MPa - Dimensions |
| ISO/DIS 9255 | Aerospace - Bolts, normal spline head, normal shank, short- or |
| | medium-length MJ threads, metallic material, coated or uncoated, strength classes less |
| | than or equal to 1 100 MPa - Dimensions |
| ISO 9256:1993 | Aerospace - Bolts, large hexagonal head, normal or pitch |
| | diameter shank, long length MJ threads, metallic material, coated or uncoated, |
| | strength classes less than or equal to 1 100 MPa - Dimensions |

Bolts that are used in industries other than the aerospace industry are covered by ICS 21, as previously shown in Table One.

Table Six shows classifications within IC 21 that cover bolts that are intended for general use:

TABLE SIX
ICS 21: Mechanical systems and components for general use

| ICS | Field |
|---|---|
| 21.020 | Characteristics and design of machines, apparatus, equipment; |
| | Including reliability, dependability, maintainability, |
| | durability, etc.; |
| | Safety of machinery, see 13.110 |
| 21.040 | Screw threads |
| | Screw threads for aerospace construction, see 49.030.10 |
| 21.060 | Fasteners |
| | Fasteners for aerospace construction, see 49.030 |
| | Fasteners related to surgery, prosthetics and orthotics, |
| | see 11.040.40 |
| 21.080 | Hinges, eyelets and other articulated joints |
| 21.100 | Bearings |
| 21.120 | Shafts and couplings |
| 21.140 | Seals, glands |
| | Seals for pipe and hose assemblies, see 23.040.80 |
| 21.160 | Springs |
| | Steels for springs, see 77.140.25 |
| 21.180 | Housings, enclosures, other machine parts |
| 21.200 | Gears |
| 21.220 | Flexible drives and transmissions |
| 21.240 | Rotary-reciprocating mechanisms and their parts |
| | Including pistons, piston-rings, crankshafts, etc. for general |
| | engineering |
| 21.260 | Lubrication systems |

Table Seven presents sub-classifications for fasteners intended for general use, ICS 21.060, as opposed to fasteners that are used for aerospace products.

TABLE SEVEN
ICS 21.060: Fasteners
Fasteners for aerospace construction, see 49.030
Fasteners related to surgery, prosthetics and orthotics, see 11.040.40

| ICS | Field |
|---|---|
| 21.060.01 | Fasteners in general |
| 21.060.10 | Bolts, screws, studs |
| 21.060.20 | Nuts |
| 21.060.30 | Washers, locking elements |
| 21.060.40 | Rivets |
| 21.060.50 | Pins, nails |
| 21.060.60 | Rings, bushes, sleeves, collars |
| 21.060.70 | Clamps and staples |
| 21.060.99 | Other fasteners |

Table Eight shows a list of twenty one ISO Standards for General Use for non-aerospace bolts:

TABLE EIGHT
ISO Standards for General Use (Non-Aerospace, Non-Medical) Bolts (21.060.10:
Bolts, screws, studs - Filtered to show bolts only)

| | |
|---|---|
| ISO 225:1983 | Fasteners - Bolts, screws, studs and nuts - Symbols and |
| | designations of dimensions |
| ISO 885:2000 | General purpose bolts and screws - Metric series - Radii under the head |
| ISO 888:1976 | Bolts, screws and studs - Nominal lengths, and thread lengths |
| | for general purpose bolts |
| ISO 898-1:1999 | Mechanical properties of fasteners made of carbon steel and |
| | alloy steel - Part 1: Bolts, screws and studs |
| ISO 898-5:1998 | Mechanical properties of fasteners made of carbon steel and |
| | alloy steel - Part 5: Set screws and similar threaded fasteners |
| | not under tensile stresses |
| ISO 898-7:1992 | Mechanical properties of fasteners - Part 7: Torsional test and |
| | minimum torques for bolts and screws with nominal diameters |
| | 1 mm to 10 mm |
| ISO 3506-1:1997 | Mechanical properties of corrosion-resistant stainless-steel |
| | fasteners - Part 1: Bolts, screws and studs |
| ISO 4014:1999 | Hexagon head bolts - Product grades A and B |
| ISO 4015:1979 | Hexagon head bolts - Product grade B - Reduced shank (shank |
| | diameter approximately equal to pitch diameter) |
| ISO 4016:1999 | Hexagon head bolts - Product grade C |
| ISO 4162:1990 | Hexagon flange bolts - Small series |
| ISO 4759-1:2000 | Tolerances for fasteners - Part 1: Bolts, screws, studs and nuts - |
| | Product grades A, B and C |
| ISO 6157-1:1988 | Fasteners - Surface discontinuities - Part 1: Bolts, screws and |
| | studs for general requirements |
| ISO 6157-3:1988 | Fasteners - Surface discontinuities - Part 3: Bolts, screws and |
| | studs for special requirements |
| ISO 7378:1983 | Fasteners - Bolts, screws and studs - Split pin holes and wire |
| | holes |
| ISO 8678:1988 | Cup head square neck bolts with small head and short neck - |
| | Product grade B |
| ISO 8765:1999 | Hexagon head bolts with metric fine pitch thread - Product |
| | grades A and B |
| ISO 8839:1986 | Mechanical properties of fasteners - Bolts, screws, studs and |
| | nuts made of non-ferrous metals |
| ISO 8992:2005 | Fasteners - General requirements for bolts, screws, studs and |
| | nuts |
| ISO 10664:2005 | Hexalobular internal driving feature for bolts and screws |
| ISO 15072:1999 | Hexagon bolts with flange with metric fine pitch thread - Small |

An analysis of the ISO Standards reproduced in Tables One through Eight reveals that even components as simple as a bolt must be manufactured in accordance with unique and specialized standards if the bolt will be used in an aerospace product or system. All other bolts in all other industries (except the medical industry) use the same standards that are promulgated for “general” non-aerospace use.

### VI. Quality Standards

In addition to the International Standards shown in Tables One through Eight, the ISO also promulgates “Quality Standards.” AS 9100, which is known as SAE AS9100 in the U.S. and identical to Europe's EN 9100, is an international standard which comprises ISO 9001 quality system requirements for non-aerospace industries supplemented by 83 additional quality system requirements unique to the aerospace industry. ISO's Aerospace Technical Committee, ISO TC 20: Aircraft and Space Vehicles, wrote AS9100:
“In addition to the requirements listed in ISO 9001, AS 9100 also includes aerospace sector specific requirements, which were felt to be necessary to assure the safety, reliability and quality of aerospace products. These include requirements in the areas of: configuration management; reliability, maintainability, and safety; design phase, design verification, validation, and testing processes; approval and review of subcontractor performance; verification of purchased product; product identification throughout the product's life cycle; product documentation; control of production process changes; control of production equipment, tools, and numerical control machine programs; control of work performed outside the supplier's facilities; special processes; inspection and testing procedures, methods, resources, and recording; corrective action; expansion of the internal audit requirements in ISO 9001; first article inspection; servicing, including collecting and analyzing data, delivery, investigation, and reporting; control of technical documentation; and the review of disposition of nonconforming product. Unlike standards in other areas, AS 9100 recognizes the role of regulatory authorities in the establishment of quality system requirements for aerospace manufacturers.”

### See National Institute of Standards and Technology.

Boeing Corporation, one of the leading aerospace companies in the world, requires all manufacturers and suppliers with whom they do business to comply with AS9100 as a condition of doing business with Boeing.

Table Nine offers an example of additional quality system requirements for the aerospace industry which are imposed by AS9100 over and beyond those of the ISO 9000 standard:

TABLE NINE

4.8 Product Identification and Traceability
In accordance with contract and requirements, Supplier's system
shall provide for:
Identification maintained through product life;
Traceability of all products from the same batch of raw material
or manufacturing batch, as well as the destination of all products
to the same batch;
Identity of components and those of next higher assembly to be
traced;
A sequential, retrievable, traceable record of production
(manufacture, assembly, inspection); and
Identification of configuration of the actual product.
AS9100 includes Section 4.9.1, which pertains to the
Aerospace Production Process:
4.9.1 Production Process
4.9.1.2 Control of Production Process Changes
4.9.1.3 Control of Production Equip, Tools & NC Machines
4.9.1.4 Control of Work Occasionally Performed Outside the
Supplier's Facilities

“When it becomes necessary to change a production process these changes must be documented. Design changes, producibility enhancements, process improvements, variation in sources of raw material, and a number of other factors may necessitate changes. The reason for the change shall be documented. The production change process shall identify those authorized to make changes to the production processes. If customer approval is required this shall be identified and the method for notifying the customer explained. Any changes to processes. production equipment, tools and programs that may effect product quality shall be documented. The procedures for implementing these changes shall be available. Every change to the material tested using an independent source or witnessing the subcontractor's inspection and test process. The process used by the supplier shall be documented. The item of importance here is discipline and documentation. The supplier cannot make changes to his production system without documenting what he's done.”

AS9100. includes 83 quality system requirements that are unique to the aerospace industry. Virtually all aerospace suppliers and vendors are required to comply with AS9100. These requirements indicate that the aerospace industry is quite different from non-aerospace industries, and is governed by different product and quality standards.

### VII. Comparison of Aerospace Industry Versus Non-Aerospace Industry Standards: Pressurized Gas Bottles

Another example of the different standards that have been promulgated for aerospace and non-aerospace versions of the same general product is shown in Table Ten. Both aerospace and non-aerospace companies need to store pressurized gas in containers called “bottles” or “tanks.” These gases are used for welding, semiconductor fabrication and other industrial purposes. Table Ten compares gas bottles that are used in aerospace and in non-aerospace products and systems:

TABLE TEN
Standards used for Aerospace Pressurized Gas Bottles
(ARDE Inc. supplies He pressure tanks to SpaceX's Falcon 1 and Boeing's Delta IV
launch vehicles)

MIL-STD-1552A, Standard General Requirements for Safe Design and Operation of
Pressurized Missile and Space Systems, 1992
EWR 127-1, Eastern and Western Range Safety Requirements
AIAA S-080-1998, Space Systems - Metallic Pressure Vessels, Pressurized
Structures, and Pressure Components
AIAA S-081-20001, Composite Overwrapped Pressure Vessels
Non-Aerospace Pressurized Gas Bottles
(Lincoln Composites Inc. supplies fuel tanks for the storage of compressed natural gas
and hydrogen for land vehicles.)
ISO 11439:2000, Gas cylinders - High pressure cylinders for the on-board storage
of natural gas as a fuel for automotive vehicles
ANSI/CSA NGV2 (2000), Basic Requirements for Compressed Natural Gas Vehicle
(NGV) Fuel Containers.
ANSI/IAS PRD 1-1998, Pressure Relief Devices for Natural Gas Vehicle (NGV) Fuel
Containers
ANSI/AGA NGV3.1-95, Fuel System Components for Natural Gas Powered Vehicles
ISO/DIS 15869.2, Gaseous hydrogen and hydrogen blends - Land vehicle fuel tanks

Table Ten reveals two functionally similar products, aerospace and non-aerospace pressurized gas bottles, are manufactured in accordance with different requirements and standards for different applications. Comparison of data and price quotes for approximately the same volume tanks from these two manufacturers showed that while the non-aerospace industry tanks generally weighed from 50 to 75% more, they cost only about 7% to 10% of that of the aerospace industry produced tanks.

### VIII. Comparison of an Aerospace Industry Product Versus a Non-Aerospace Industry Product: Valves & Actuators

A third comparison of functionally similar aerospace and non-aerospace products is provided in Table Eleven:

TABLE ELEVEN
Aerospace Industry Product

| | |
|---|---|
| Description: | 2″ Cryogenic Ball Valve with Pneumatic Actuator |
| Manufacturer: | Moog - Space Products Division |
| Port Size: | 2.16 inch |
| Weight: | 6.6 lbm |
| Operating Pressures: | Valve 75 lbf/in² |
| | Actuator 500 lbf/in² |
| Operating Temps: | −423° F./−320° F. |

Non-Aerospace Industry Product

| | |
|---|---|
| Description: | MCF 2″ Cryogenic Ball Valve + Morin Pneumatic |
| | Actuator |
| Manufacturer: | MCF/Morin |
| Port Size: | 1.50 inch |
| Weight: | 9.0 lbm + 7.5 lbm = 16.5 lbm total |
| Operating Pressures: | Valve 750 lbf/in² |
| | Actuator 120 lbf/in² |
| Operating Temps: | −425° F./−20° F. |

Table Eleven shows that the aerospace industry produced version of the valve and actuator product weighs only about 40% of that of the non-aerospace industry produced, functionally similar, COTS version. However, cost estimates show the non-aerospace COTS system costs only 5-10% of the aerospace COTS system. This comparison illustrates significant potential cost savings possible for an aerospace flight vehicle designed with enough performance margin to use the significantly heavier, but far lower cost, non-aerospace COTS valve/actuator version.

Table Twelve presents a comparison of the number of vendors in the United States and Canada who produce valve and actuator products for both the aerospace and non-aerospace industries:

TABLE TWELVE
Searches for valve suppliers in the U.S. and Canada
See: ThomasNet, an industrial product/service search engine

| | |
|---|---|
| 2,446 | Suppliers: non-aerospace ball valves |
| 316 | Suppliers: non-aerospace cryogenic valves |
| 19 | Suppliers: aerospace valves |
| 4 | Suppliers: aerospace cryogenic valves |

These search results indicate that the number of non-aerospace cryogenic valves suppliers is roughly eighty times the number of aerospace cryogenic valves suppliers in the U.S. and Canada.

Table Thirteen furnishes additional information regarding applications and standards which pertain to the valve and actuator products of Table Eleven.

TABLE THIRTEEN
Aerospace Industry Valve & Actuator Products
Applications & Standards
Application: Currently qualified and in production for use on the
Pratt & Whitney RL-10 rocket engine
Non-Aerospace Industry Valve & Actuator Products
Applications & Standards
Applications: Gas Liquification, Food Processing, Transport/Tank
Trucks, Truck Loading Stations, Testing Stations, Sample Lines,
Transfer Lines, Aerospace
Valve
Valve built to ISO 5211 and offers options for ANSI and Mil
STD connections
Major material is standard 316 stainless steel
Actuator
Actuator designed to conform with ISO 5211 and ISO 3768
Built primarily from standard aluminum and components conforming
to international material standards (ASTM, BS, and DIN)

Table Thirteen demonstrates that aerospace products and systems are unique custom designs with few applications, few customers, and hence have extremely low production volumes, as compared to non-aerospace COTS products and systems, which are manufactured in accordance with international standards, which have many applications and which have many customers across the globe.

### IX. Typical Aerospace Industry Manufacturing Methods

Because aerospace vehicles are generally weight minimized, aerospace industry manufacturing methods generally differ considerably from non-aerospace industry manufacturing methods. Aerospace industry commonly uses very high strength and lightweight exotic alloys such as titanium alloys or aluminum-lithium that require special fabrication techniques such as precision casting, thermal forming, precision machining, chemical milling, and special welding techniques such as stir friction welding. Both aerospace raw materials and their associated fabrication processes are generally extremely expensive compared to their non-aerospace industry counterparts. Historically, titanium costs five to ten times as much per pound as stainless steel, and five to seven times that of aluminum. Aluminum alloys can be very expensive as well; aluminum-lithium, for example, a material used in the Space Shuttle External Tank, can cost more than titanium. Further, the specialized fabrication methods required by some of these alloys can be far more expensive than the standard non-aerospace industry manufacturing methods used for conventional materials such as stainless steel. Recently, the cost of titanium has soared as increasing demand has outstripped production. In 2007 titanium prices had risen to their highest level in two decades to over $12 per pound for aerospace-grade material (see Aerospace America, “Russia's raw materials business on the rise,” January 2008). In contrast, in the same timeframe stainless steel stock prices were around $2 per pound. While commonly used in non-aerospace industries, due to its lower strength-to-weight ratio stainless steel is rarely used in aerospace applications except for fasteners.

In aerospace component manufacturing, structural parts are commonly machined from thick plates of titanium and aluminum alloys. A vast majority of the raw material is typically machined away, with the final part often weighing less than 5% of the original material blank (one wing rib discussed in an article on Modern Machine Shop Online weighed 11.2 ounces when finished, less than 3% of the 24 lb weight of the original billet of raw material.) This approach is expensive, but it gives the designer almost limitless flexibility to transition thickness and optimize the design of the structural joints. Commercial aircraft wing ribs are manufactured in this manner. Although Boeing and Airbus commercial aircraft today use more composite parts than ever before, wing ribs are still made from aluminum alloys. Airbus A380 wing ribs, for example, are single-piece parts that are computer-driven, automatically machined from an individual billet of a high-tensile strength aluminum alloy. Raw material cost alone of each rib can exceed $20,000 and a process had to be designed to avoid the partially completed rib from being buried in aluminum chips during fabrication.

Many space launch vehicle components are also fabricated with precision machining. Delta IV hydrogen and oxygen propellant tanks are machined from aluminum in an isogrid pattern, and the current hydrogen tank design in the Space Shuttle's External Tank is a machined orthogrid panel design made from aluminum-lithium. Advanced materials often require advanced welding methods such as friction-stir welding for aluminum alloys.

Such cost and complexity is by no means limited to large aerospace vehicles. According to one manufacturer, each part for a wing for the US Army's 16.5 ft long Tactical Hawk Missile has to be precision formed, machined, and assembled, and each wing requires 3,000 operations to fabricate.

Chemical milling is also frequently used to produce very thin, exact aerospace components. Material weight reductions of 75% or more are not uncommon, especially for aircraft fuselage skins and rocket propellant tanks.

Often, several of these fabrication processes are used together to create a single product. The Shuttle's oxygen tank, for example, is an aluminum monocoque structure made of a fusion-welded assembly of preformed components including ring chords, machined fittings, chemically-milled gores, and panels, and like most space launch vehicle propellant tanks, includes anti-vortex and anti-slosh baffles.

The large scale of many aerospace vehicles, especially coupled with common assembly clean room requirements, contributes significantly to cost. Highly specialized tooling and facilities are generally necessary to produce aerospace components and assemblies.

This is especially the case for space launch vehicles, each type of which are generally built in numbers ranging from merely a single to a dozen vehicles each year. Space launch vehicle production facilities thus generally operate at especially low production rates with almost negligible rate effects and economies of scale relative to non-aerospace industry production. Since they are also so specialized, space launch vehicle production facilities generally can not be used for other purposes and are usually highly underutilized, contributing to the very high fixed costs common to that industry.

Transportation costs for delicate aerospace components that often require special handling and packaging can be large. Transportation costs can be especially high for large completed assemblies such as rockets, which generally can not use standardized transportation means due to size and fragility. Boeing, for example, has a dedicated ship, the 312-foot long Delta Mariner, to ferry Boeing Delta IV rockets from its Alabama, factory to launch sites in Florida and California. The Space Shuttle's solid rocket motors, for example, are transported from their Utah factory to the Florida launch site by rail on a special dedicated train. Hazardous cargo restrictions especially impact the means and costs of solid rocket booster transportation.

### X. Typical Aerospace Vehicle Costs

Aerospace vehicle costs are very high relative to most non-aerospace products including vehicles. One 1997 paper asserts that aircraft manufacturing costs about $275/lb and rockets cost about $2,300/lb of dry weight (See Jay Penn, Charles Lindley, The Aerospace Corporation, “Requirements and Approach for a Space tourism Launch System,” IAA-97-IAA.1.2.08, page 10, presented at the 48th International Astronautical Congress, Turin, Italy, Oct. 6-10, 1997). A more recent estimate of the cost for commercial aircraft is significantly higher. According to a Boeing website, the current price of the 777-200LR aircraft is $231M to $256.5M, or about $700/lb -$800/lb of dry weight. This price, of course, includes a lot of other costs including amortization of research and development, marketing, etc., but is eased somewhat by relatively high production rates, at least compared to rockets. High performance military aircraft and missiles can easily cost three to five times this amount per pound. In contrast, a new 2008 Toyota Camry hybrid sedan costs about $24,000 in late 2007 and weighs about 3,700 lb for a cost/lb of about $6.50/lb. Satellites and space vehicles usually cost far more than aircraft and can easily exceed $20,000/lb. One recent United States Air Force satellite, TacSat2, weighed about 660 lb and cost about $40M, or about $60,000/lb. Rocket hardware costs are difficult to discern due to the very high fixed costs factored in and thus depend strongly on launch rate. Over the life of the EELV program to date, Atlas V launches for example have cost the US government between $72M and $232M per Launch (see Jim McAleese, “U.S. Air Force Can lead by Example on ULA,” Space News, Nov. 28, 2005. Assuming $100M/launch for an Atlas V 400 vehicle, which has a dry weight of roughly 56,000 lb (Atlas Launch System Mission Planner's Guide, Atlas V Addendum, page 14) produces a cost to the user of about $1,800/lb. These estimates are supported in numerous sources. One 1994 study notes advanced composite structures cost from $600-$800/lb of finished structure for combat aircraft, $250-$400/lb for commercial airliners and from $1,000-$10,000/lb for spacecraft and missiles. John London's October 1994 “LEO on the Cheap: Methods for Achieving Drastic Reductions in Space Launch Costs,” provides several examples of costs per pound of dry weight for then current expendable launch vehicles ranged from $1,000 to $3,000/lb. Smaller rockets such as the Pegasus are far more expensive per pound than larger rockets like the Atlas V. Thus, cost estimates per unit of dry weight is in the range of $5/lb-$10/lb for an ordinary automobile (and popular luxury cars perhaps around $20/lb), $250-$800/lb for a commercial aircraft, $1,000/lb-$10,000/lb for a space launch vehicle, and $10,000/lb-$50,000/lb for a satellite with the lower number in each range probably better representing the relatively low cost structure.

### XI. NASA & DoD Definitions: Commercial Off-The-Shelf Products

NASA defines commercial off the shelf products, or “COTS,” as follows:
“Commercial Off the Shelf (COTS): Commercial items that require no unique Government modification or maintenance over the life cycle of the product to meet the needs of the procuring agency. A commercial item is one customarily used for non-Governmental purposes that has been or will be sold, leased, or licensed (or offered for sale, lease, or license) in quantity to the general public. An item that includes modifications customarily available in the commercial marketplace or minor modifications made to meet NASA requirements is still a commercial item.”
   See NASA Requirements for Ground-Based Pressure Vessels and Pressurized Systems (PV/S) Measurement, NASA TECHNICAL STANDARD, NASA-STD-8719.17, Approved: 2006-09-22, Expiration Date: 2011-09-22, Section 3.2 Definitions page 12.

The Department of Defense, “DoD,” defines commercial off the shelf products, and provides some insight and lessons learned on their application, as follows:
“A commercial item is one customarily used for nongovernmental purposes that has been or will be sold, leased, or licensed (or offered for sale, lease, or license) to the general public. An item that includes modifications customarily available in the commercial marketplace or minor modifications made to meet federal government requirements is still a commercial item. In addition, services such as installation, maintenance, repair, and training that are procured for support of an item described above are considered commercial items if they are offered to the public under similar terms and conditions or sold competitively in substantial quantities based on established catalog or market prices.”
“A commercial off-the-shelf (COTS) item is one that is sold, leased, or licensed to the general public; offered by a vendor trying to profit from it; supported and evolved by the vendor who retains the intellectual property rights; available in multiple, identical copies; and used without modification of the internals.”
“Programs have, on occasion, purchased commercial items they assumed to be COTS that were really versions of systems used in-house or custom-produced for another organization. In one case, the one-of-a-kind item purchased did not represent best commercial practice and had no user base or established distribution and support system. The program was subsequently cancelled. In another case, a contractor claimed that dozens of commercial items were being incorporated into a system; the program wrongly assumed that the commercial items were COTS. A post-delivery examination exposed these items to be little more than contractor-specific tools and scripts. As a result of these contractor-specific items, the program was unable to reconstruct the system without the long-term support of the contractor—an outcome they had hoped to avoid.”

### See Commercial Item Acquisition: Considerations and Lessons Learned Jun. 26, 2000.

Another DoD definition of COTS is:

### “Operational Definition of COTS

The government's definition of a COTS item is found in the Federal Acquisition Regulation (FAR) 2.101, and states the following: (1) Any item, other than real property, that is of a type customarily used by the general public or by non-governmental entities for purposes other than governmental purposes, and has been sold, leased, or licensed to the general public; or, has been offered for sale, lease, or license to the general public; 2) Any item that evolved from an item described in paragraph (1) of this definition through advances in technology or performance and that is not yet available in the commercial marketplace, but will be available in the commercial marketplace in time to satisfy the delivery requirements under a Government solicitation.”

See: Criteria for Selection of Cots Equipment in a Military System, Barry Birdsong—Chairman of the THAAD Parts Review Board, US Army Aviation and Missile Command, Redstone Arsenal, AL, Keith Walker—RAM Engineer for the THAAD Weapon System, US Army Aviation and Missile Command, Redstone Arsenal, AL.
“Military systems are typically required to have a service life of 20 years or greater. The usage of COTS equipment in a military system imposes added risks in the areas of reliability and supportability. Additionally, the users of COTS equipment have no control over the in-process design and manufacturing aspects of the hardware. Whereas this results in significant Non-Recurring Engineering (NRE) cost savings, it introduces new risks that require the user of COTS equipment to rely on a thorough review of all available data to assure the hardware will fit the application. A common misconception on the use of COTS in the military is that COTS hardware will provide the latest available technology and therefore better prepare the soldier. However, COTS that employ the latest in technology are often not rugged enough for military applications and are designed to only meet the one year warranty at best. Therefore, maturity of the COTS item is an important consideration, as the more mature COTS items that have been tested by the commercial market will typically be more suitable for military designs. This in turn can lead to obsolescence issues by the time the system is fielded.”

The Federal Acquisition Regulations contain the following definitions concerning COTS:
“As defined in subsection (c) of 41 U.S.C. 431 (Section 35 of the Office of Federal Procurement Policy Act), ‘COTS item’
(i) Means any item of supply that is
   (A) A commercial item;
   (B) Sold in substantial quantities in the commercial marketplace; and
   (C) Offered to the Government, without modification, in the same form in which it is sold in the commercial marketplace; and
(ii) Does not include bulk cargo, as defined in section 3 of the Shipping Act of 1984 (46 U.S.C. App. 1702), such as agricultural products and petroleum products.”

According to the National Contract Management Association:

“DoD continues to issue memoranda including the following:
This Oct. 26, 2007, Deviation, among other things, “adds a definition for “commercially available off-the-shelf item” as well as adding the “exception for specialty metals contained in” such items.
“Commercially available off-the-shelf item”
(i) “Means any item of supply, including any component, that is
   (A) A commercial item (as defined in FAR2.101);
   (B) Sold in substantial quantities in the commercial marketplace;
   (C) Offered to the Government, without modification, in the same form in which it is sold in the commercial marketplace and
(ii) “Does not include bulk cargo, as defined in section 3 of the Shipping Act of 1984 . . . ”

Conventional aerospace manufacturing methods do not generally utilize production methods that maximize the use of readily available, non-aerospace COTS components, and are not generally designed to produce components in mass quantities to leverage high levels of economies of scale. The development of such a system would constitute a major technological advance, and would satisfy long felt needs and aspirations in the aerospace industry.

### SUMMARY OF THE INVENTION

The present invention comprises methods and apparatus for reducing the manufacturing costs in an aerospace product. In one embodiment, this method is accomplished by designing the aerospace product to use non-aerospace industry components and by maximizing the use of said plurality of readily commercially available, non-aerospace industry components. These non-aerospace commercially available, components are sometimes referred to by the term “commercial off the shelf” or “COTS” products. Some of these readily commercially available, non-aerospace industry components include commodities which are commonly available, or which are manufactured by a number of vendors. These vendors produce the commodities in accordance with commonly held non-aerospace performance standards.

In another embodiment, the invention is accomplished by reducing fixed and recurring costs in manufacturing an aerospace product, and by maximizing the use of readily commercially available, non-aerospace industry manufactured components. According to one embodiment of the invention, the use of aerospace industry manufacturing materials and methods is minimized. Aerospace products are designed using as many readily commercially available, non-aerospace industry manufactured components for fabrication, integration, assembly and test as possible; and by designing the aerospace product to use large quantities of these components to leverage high levels of economies of scale.

In another embodiment of the invention, the use of aerospace industry manufacturing materials and methods is minimized. Aerospace products are designed to use as many readily commercially available, non-aerospace components as possible, but when these parts can't be used, the method is accomplished by designing the aerospace product to use components designed to be manufactured by non-aerospace industry using conventional commercial, low-cost materials, manufacturing methods, and non-aerospace standards; and by designing the aerospace product to use large quantities of these components to leverage high levels of economies of scale.

The invention requires great care in designing the aerospace vehicle to properly employ non-aerospace manufactured components to ensure they are properly protected from harsh temperature, vibration, acceleration, acoustic, radiation, and other aerospace environmental loads. In some cases, shielding or isolating compartments, brackets, or other apparatuses may be used.

The invention also generally requires a very strict minimal-cost for “good enough” system performance design approach, rather than the traditional aerospace minimum-weight for maximum system performance design approach. The invention thus generally produces an aerospace system design that although is functionally equivalent to that produced by a typical aerospace design approach, is generally somewhat heavier and far less expensive.

The invention may produce an aerospace system design that is not economical for some reusable aerospace vehicles where operating costs are far more important than initial vehicle fabrication costs. This may be the case for large commercial passenger aircraft where fuel prices dominate overall operating costs and fuel usage is greatly impacted by vehicle weight.

The invention is best suited for producing very low cost, non-reusable, aerospace vehicles. In particular, the invention is ideal for producing very low cost missiles, boosters, and space launch vehicles.

### A BRIEF DESCRIPTION OF THE DRAWINGS

FIG. 1 is a chart which illustrates the various kinds of content of a typical, conventional aerospace product.

FIG. 2 is a chart which illustrates the various types of content of an aerospace product and system manufactured in accordance with the present invention.

FIG. 3 is a flow chart depicting typical current art for acquiring an aerospace component.

FIG. 4 is a flow chart showing the method of the present invention for acquiring an aerospace component.

FIG. 5 is a flow chart which illustrates one of the methods of the invention to optimize an aerospace vehicle or product design.

FIG. 6 is a pictorial view of an aerospace system, a rocket.

FIG. 7 furnishes a cut-away view of the rocket shown in FIG. 5, showing a fuel tank within the rocket.

FIG. 8 is an inward perspective view of an integrally stiffened skin panel machined with an isogrid pattern.

FIG. 9 is a cut-away view of an alternative propellant tank to the one shown in FIG. 8, showing a radial bulkhead located within the propellant tank.

FIG. 10 is an exploded view of the propellant tank shown in FIG. 9.

FIG. 11 is a view of a roll of stainless steel.

FIG. 12 offers a view of a completed sheet metal blank that is ready to be stamped.

FIG. 13 supplies a view of a completed part in the punch and die tool after stamping.

FIG. 14 depicts autonomous five-axis laser trimming.

FIG. 15 is a view of radial bulkhead clips.

FIG. 16 shows one possible tank end closeout.

FIG. 17 shows the tank closeout being manufactured on a draw form press.

### A DETAILED DESCRIPTION OF PREFERRED & ALTERNATIVE EMBODIMENTS

### I. Overview of the Invention

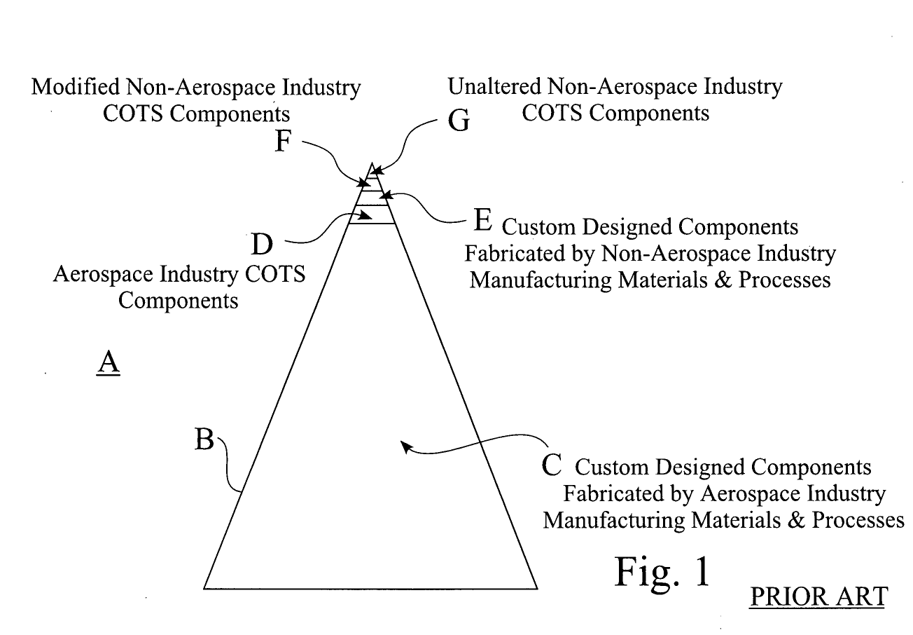

As noted in the Background section, FIG. 1 is a graphical representation A of the relative typical content of an aerospace product produced using conventional aerospace manufacturing methods. The triangle B represents the total product content of a typical aerospace product. The area of each segment of the triangle represents a category of product content, as measured by part counts. The largest segment of the triangle represents custom designed components fabricated by aerospace industry C using conventional aerospace standards and manufacturing materials and processes. For a typical aerospace vehicle, custom aerospace components make up more than 90% of the vehicle; discounting fasteners such as rivets, this number is probably somewhere between 95% and 99%. The other four areas of the triangle, aerospace industry COTS components D, custom-designed components fabricated by non-aerospace industry manufacturing materials and processes E, modified non-aerospace industry COTS components F, and unaltered, non-aerospace industry produced COTS components G, make up relatively very small portions of the overall aerospace product. Indeed, it is rare to find any non-aerospace industry parts in an aerospace product.

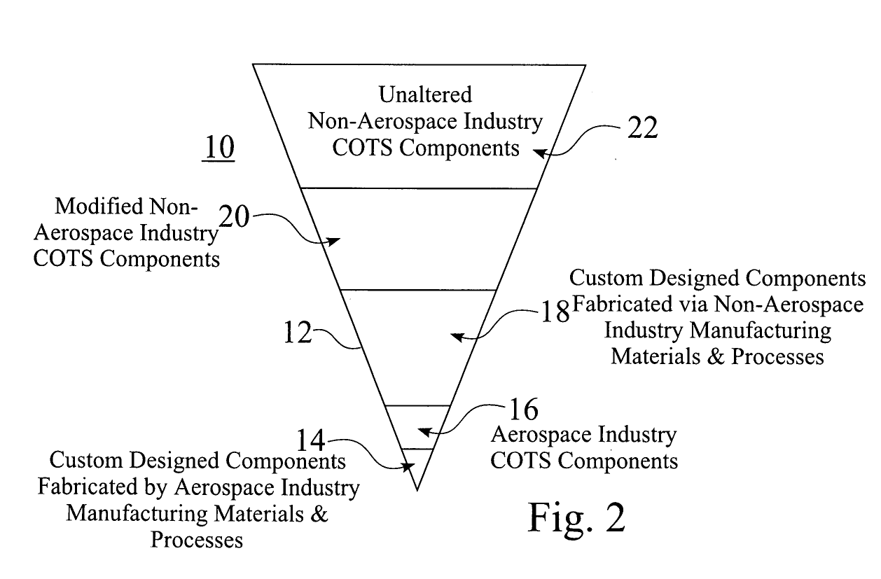

FIG. 2 is a graphical representation 10 of the relative typical content of an aerospace product produced using the method of the present invention. Comparison with FIG. 1 shows that the relative content of an aerospace product has been dramatically changed. Instead of the vast majority of the aerospace product being comprised of custom designed parts manufactured by the aerospace industry or aerospace COTS parts, all which confirm to aerospace industry standards, more than 90% of the aerospace product is built by non-aerospace industry using conventional commercial materials, manufacturing methods, and standards.

The area of each segment of the triangle 12 represents a category of product content, as measured by part counts. The largest segment of the triangle 12 represents unaltered, non-aerospace industry produced COTS components 22. The other four areas of the triangle, aerospace industry COTS components 16, custom-designed components fabricated via non-aerospace industry manufacturing materials and processes 18, modified non-aerospace industry COTS components 20 and custom designed components fabricated by aerospace industry manufacturing materials and processes 14.

In one of the preferred embodiments of the method of the present invention, the use of components created from non-aerospace industry conventional commercial manufacturing materials, methods, and standards is maximized, and the use of components created from aerospace industry components, materials, and manufacturing methods is minimized in the production of an aerospace product.

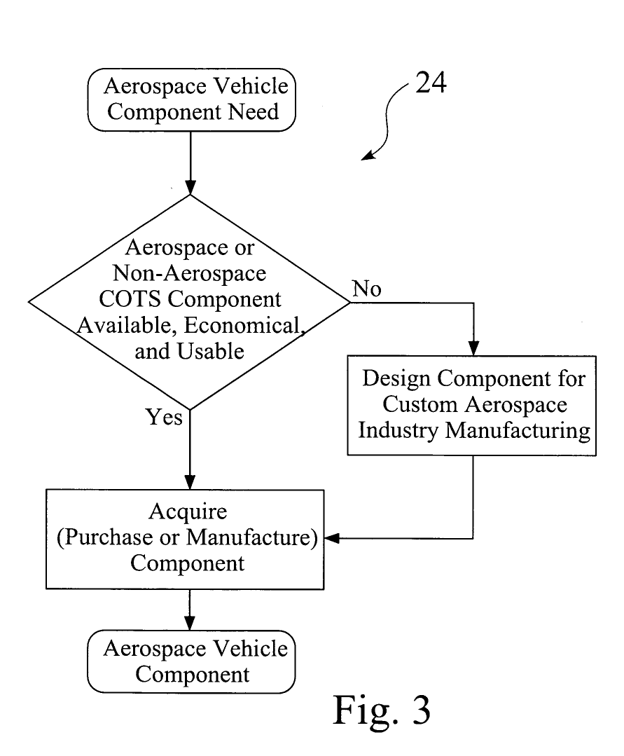

FIG. 3 is a flow chart 24 depicting typical current art for acquiring an aerospace component. An aerospace vehicle component need results in an assessment of the ability of available aerospace and non-aerospace COTS components to fulfill that need. This assessment typically involves economic and overall system and subsystem design requirements analyses, and rarely results in a COTS selection. Since non-aerospace COTS components almost never meet aerospace weight goals and very rarely meet aerospace standards, they are generally not used by current art aerospace products. Even aerospace COTS components are not commonly used, except perhaps for very basic parts such as fasteners. Due to the overall aerospace vehicle maximum performance/minimum weight design approach taken by aerospace product designers and the high cost of design, current art is generally very adverse and thus only very rarely modifies overall aerospace product design to accommodate either non-aerospace or aerospace COTS components.

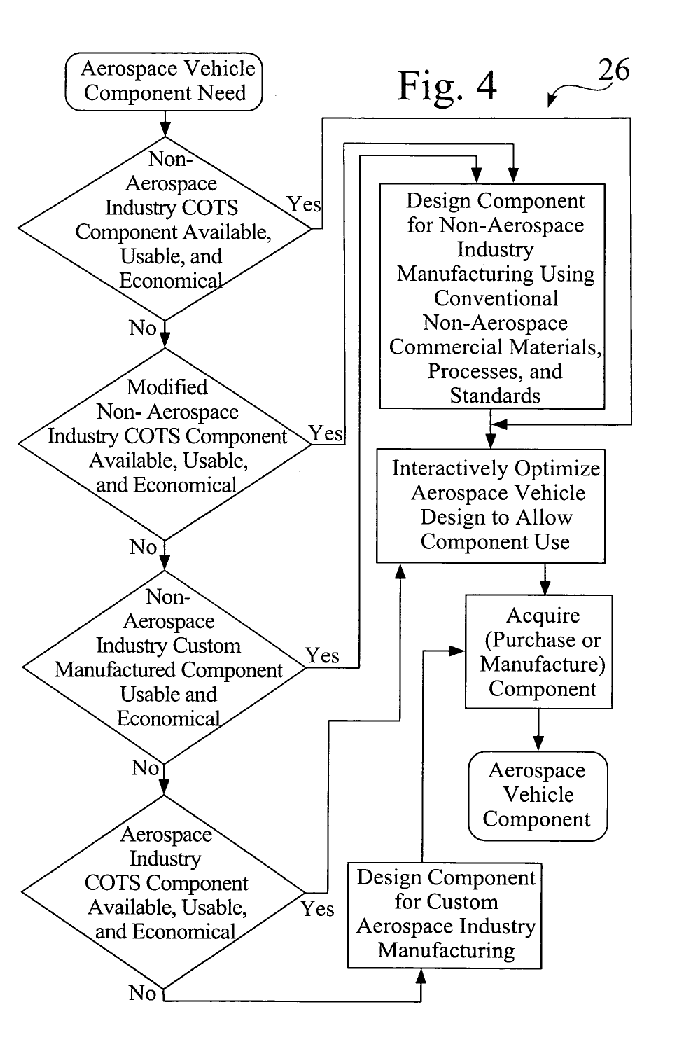

FIG. 4 is a flow chart 26 showing the method of the present invention for acquiring an aerospace component. An aerospace vehicle component need results in an assessment of the ability of available non-aerospace COTS components to fulfill that need. As with current art, this assessment typically involves economic and overall system and subsystem design requirements analyses. In sharp contrast to current art, however, this assessment is driven by an aerospace vehicle minimum cost design approach that embraces aerospace product design iterations to accommodate low cost, high quality, non-aerospace COTS components. If non-aerospace COTS components are unavailable, unusable, or not economical, the next step is an assessment of the ability of modified non-aerospace COTS components to fulfill the aerospace vehicle component need. If a customized non-aerospace COTS component can fulfill the need, it is specifically designed to be manufactured by non-aerospace industry using conventional non-aerospace commercial materials, processes, and standards.

As indicated in the flow chart shown in FIG. 4, if neither unaltered nor customized non-aerospace COTS components can be used, the method then is to custom design the component to be manufactured by non-aerospace industry using conventional non-aerospace commercial materials, processes, and standards. A preferred embodiment is to design the component to leverage best-of-practice, low-cost, and high-quality commercial, non-aerospace manufacturing techniques which result in very low product manufacturing costs. Another preferred embodiment is to design the aerospace product and product component such that the component is used in large numbers and thus can be mass produced and leverage high levels of economies of scale. A further preferred embodiment is to design the aerospace product component in such a way to enable low-cost, high-quality, automotive industry fabrication, integration, and testing.

Only when non-aerospace industry produced components can not economically meet the component needs does the method turn to aerospace industry manufacturing. For this case, priority is first given to considering aerospace COTS components to fulfill the component needs. Only as a last resort does the method turn to designing the component for custom aerospace industry manufacturing.

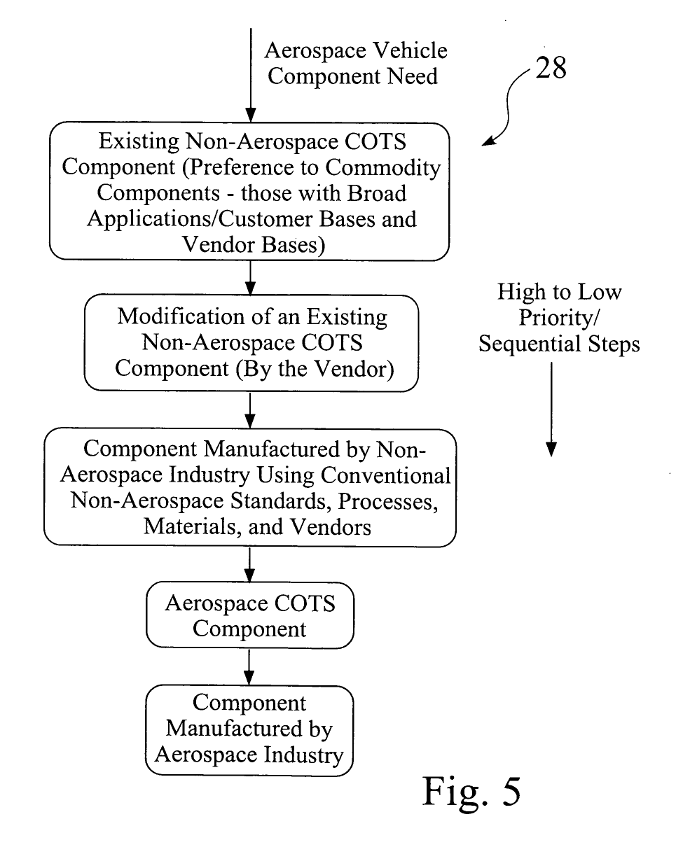

FIG. 5 is a flowchart 28 which illustrates the method of iteratively optimizing the overall aerospace vehicle or product design to minimize manufacturing, integration, testing, and operational costs by means of incorporating said aerospace and non-aerospace industry manufactured components. The general goal is to allow maximum use of these readily commercially available, non-aerospace industry manufactured COTS components, and non-aerospace industry manufacturing of all other components where economics, quality, and performance considerations allow. Preferred embodiments are aerospace product designs with significantly higher-than-traditional operational performance margins and failure tolerance; in some cases these aerospace products may have greater gross weights than traditional, performance optimized/weight minimized designs. A further preferred embodiment is designing the aerospace product for mass production in order to leverage high levels of economies of scale. Another preferred embodiment may be to out-source the assembly, integration, and test of the complete aerospace product to a non-aerospace industry manufacturer in order to significantly reduce personnel and facility fixed costs.

An example of applying this method of the present invention resulted in designing a propellant feed system for a space launch vehicle's rocket engines using the non-aerospace industry manufactured COTS actuators and valves instead of their aerospace industry counterparts, both indicated in Table Eleven.

Another example of applying this method of the present invention resulted in designing a blow-down propellant pressurization system for a space launch vehicle using the non-aerospace industry COTS manufactured pressure tanks instead of their aerospace industry counterparts, both indicated in Table Ten.

Another example of applying this method of the present invention resulted in designing a propellant (fuel or oxidizer) tank for a space launch vehicle. In this example, neither non-aerospace COTS components nor customized non-aerospace COTS were found to be economical, and thus the propellant tanks were designed to be fabricated using conventional non-aerospace industry materials, manufacturing methods, and standards, instead of conventional aerospace industry materials, manufacturing methods, and standards.

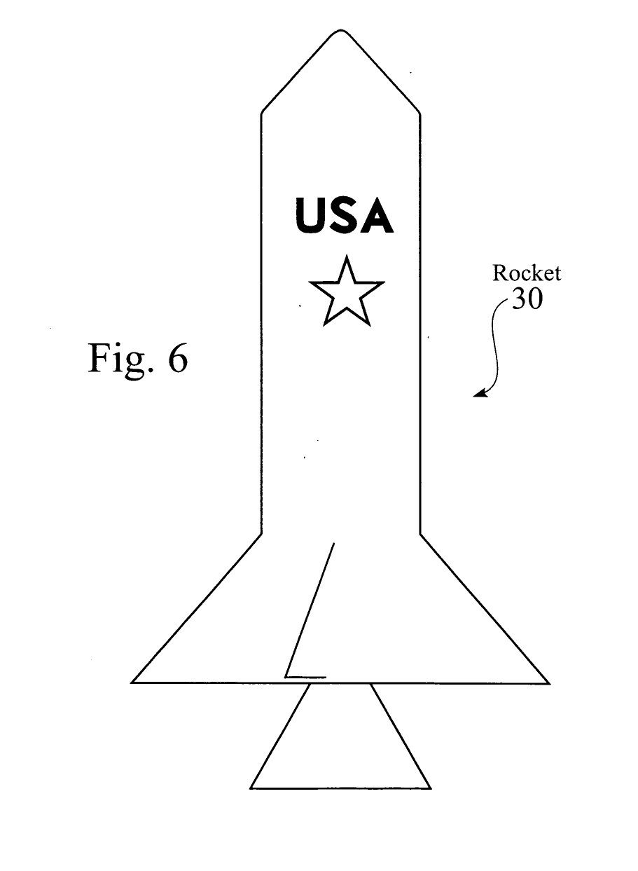

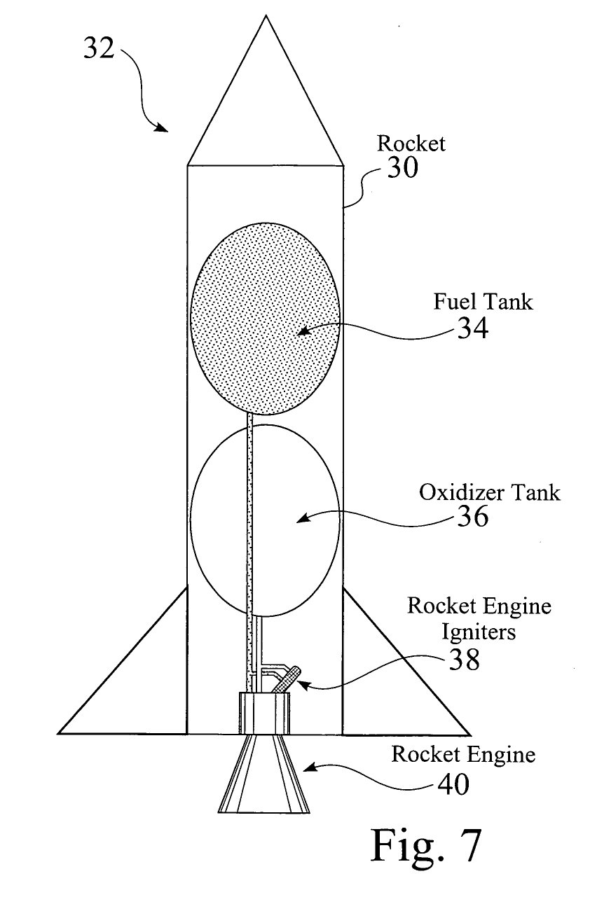

FIG. 6 depicts a rocket 30. FIG. 7 finishes a cut-away view 32 of the rocket shown in FIG. 6, showing a fuel tank 34, an oxidizer tank 36, and rocket engine igniters 38 within the rocket 30. A rocket engine 40 is shown at the base of the rocket 30. A typical industry approach of manufacturing a rocket propellant tank 34 is by precision machining relatively thick aluminum alloy material blanks into large isogrid-patterned skin panels and then friction-stir welding these skin panels together, and adding an anti-vortex and slosh baffle assembly. Such a skin panel is integrally stiffened by the isogrid which is located on the inside of the tank, allowing the tank to be lightweight and strong enough not to require any other stiffening structures such as hoops.

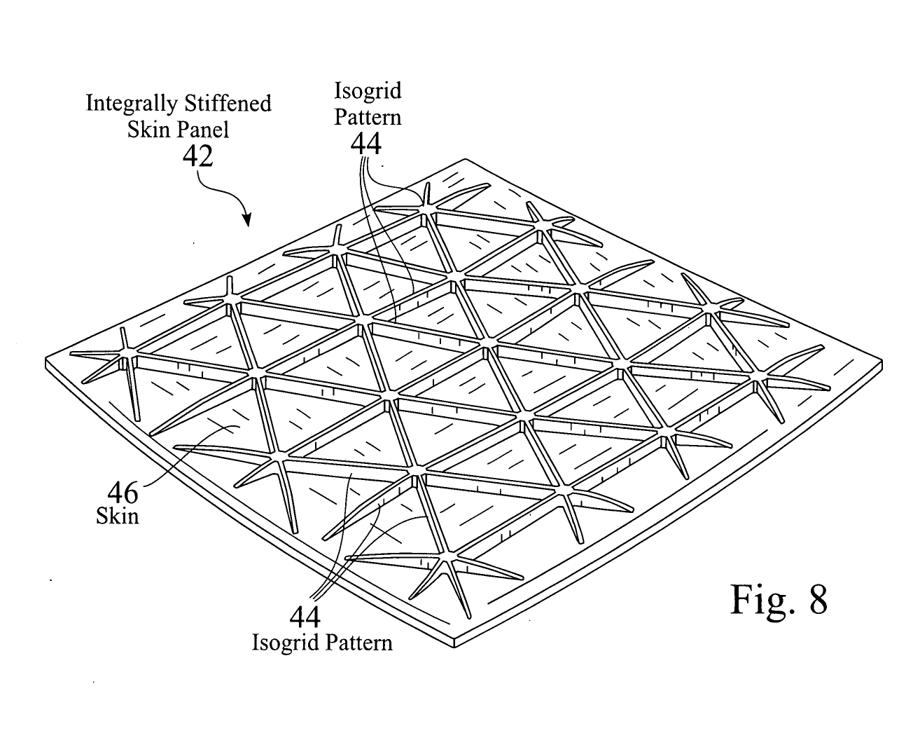

FIG. 8 is an inward perspective view of an integrally stiffened skin panel 42 machined with an isogrid pattern, representing a fundamental part of a typical aerospace industry-produced rocket propellant tank. The isogrid pattern 44is formed from machining away excess material from the skin 46. In many cases, exotic and very expensive aluminum alloys are used such as aluminum-lithium. Such alloys often are accompanied by relatively very expensive fabrication methods such as stir-friction welding. The propellant tanks on both the Atlas V and Delta IV, the U.S. Air Force's latest generation space launch vehicles, are formed from aluminum alloy isogrid skin panels that are welded together using stir-friction welding techniques. Other industry approaches exist such as welding together cylindrical barrel-panels, ring frames, and an anti-vortex and slosh baffle assembly, but are not shown here.

Instead of an integrally stiffened skin panel, using the present invention, a rocket propellant tank can be fabricated from ordinary commercial, non-aerospace industry materials and manufacturing processes such as stainless steel and common automotive-like manufacturing techniques. There are, of course, an infinite variety of such designs and just one of these is considered here.

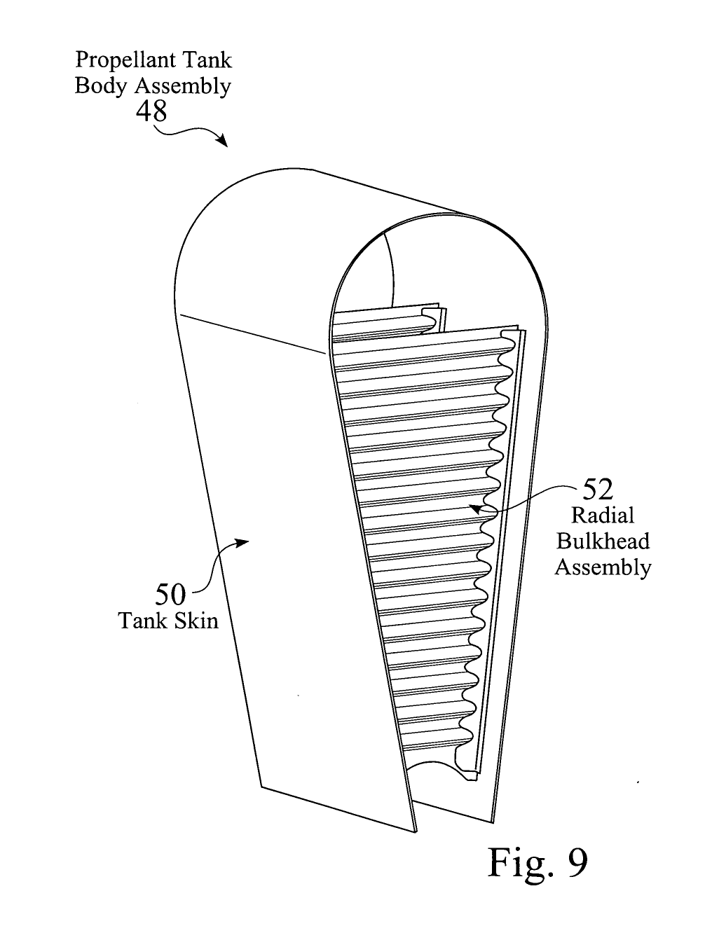

FIG. 9 shows a propellant tank body assembly 48, representing a fundamental portion of a non-aerospace industry produced rocket propellant tank. The propellant tank body assembly 48 is composed of a tank skin 50 welded to radial bulkheads 52 that serve as stiffeners. Multiple propellant tank body assemblies are welded together along with closeouts on the ends and bottom of the tank (not shown) to form a complete propellant tank. Instead of aluminum alloys, the entire tank including all of its components is made from uniform thickness American National Standards Institute (ANSI) Type 301 stainless steel coil stock. All formed components can be stamped or draw-formed on existing equipment available within the United States. The components are joined together using standard, low cost, resistance welding techniques.

The radial bulkheads 52 serve multiple functions in the fuel tank 34 and oxidizer tank 36. They reinforce the skin and structurally subdivide the tank into smaller compartments. This compartmentalization stiffens the tank enabling it to be handled and transported without internal pressure or special handling fixtures, an extreme rarity in space launch vehicle logistics. The bulkheads also support the outer skins of the tank enabling it to carry differential pressure for the case where more than one tank is used side-by-side. Further, the non-hermetic bulkheads provide fluid compartmentalization, dampening high-energy slosh modes within the tank. This minimizes vehicle control issues associated with structural-fluid coupling.

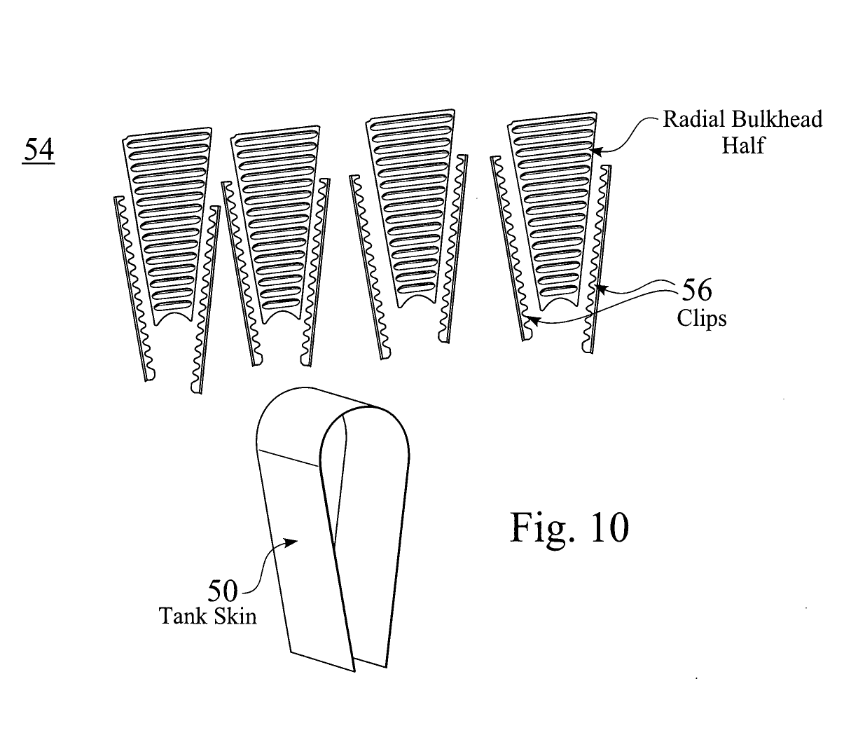

The radial bulkheads have been strategically designed for very low cost automated manufacturing. The radial bulkheads are an assembly of two identical stamped and laser trimmed components welded back-to-back with welded clip sets to create an approximate 4 feet long by 2 feet wide (˜1 feet at its base) structural member (FIG. 10). The stampings are made from standard ANSI 301 stainless steel stock. When joined together with individual resistance spot welds, they form an integrated truss work.

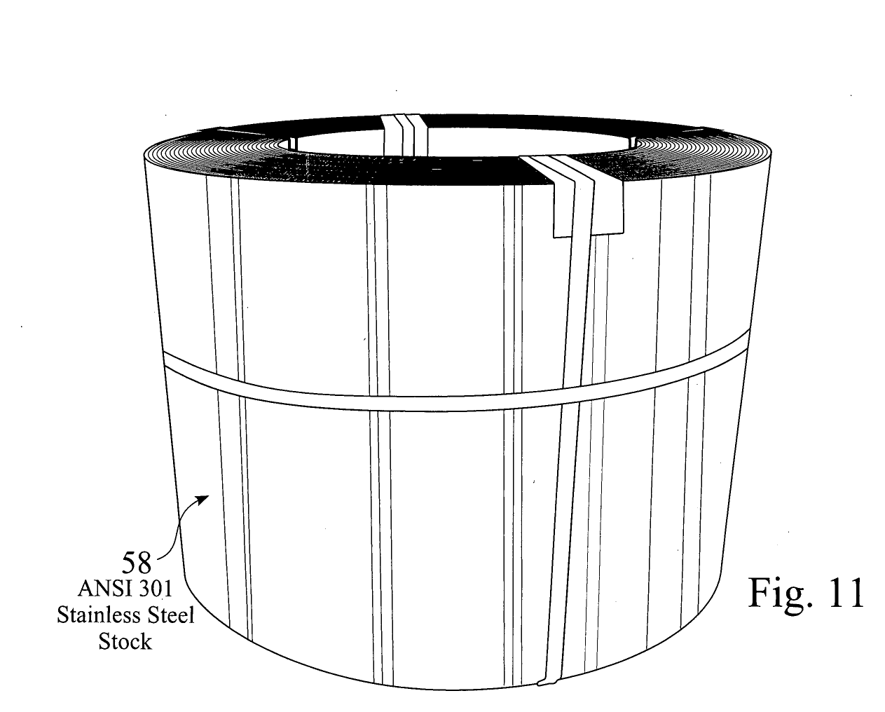

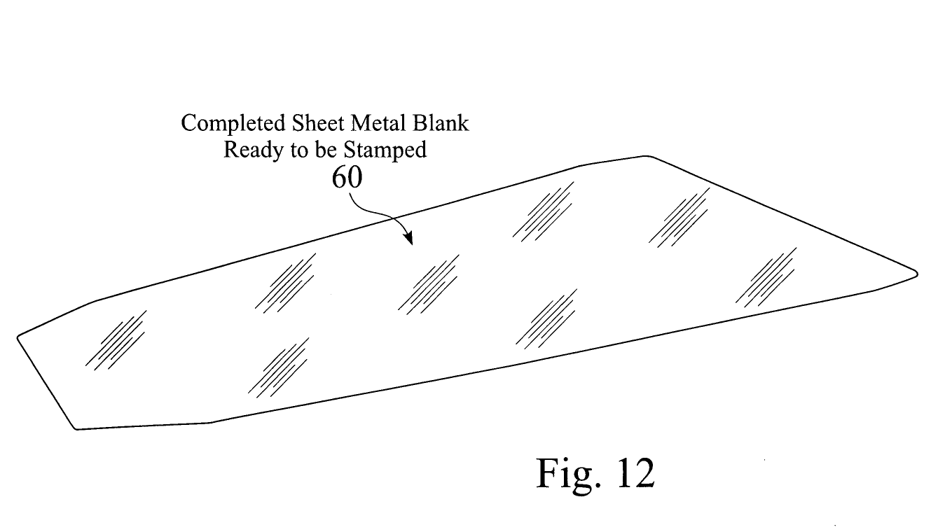

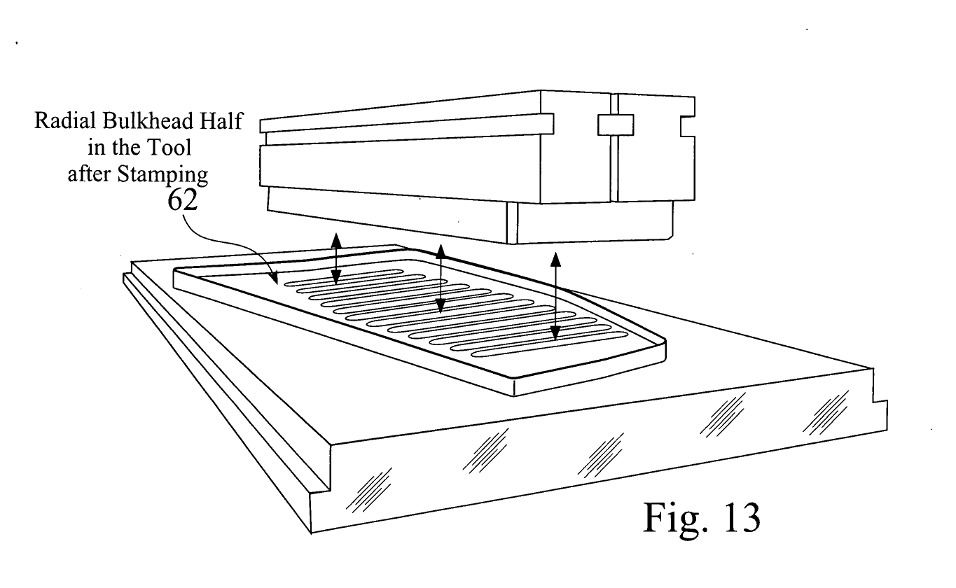

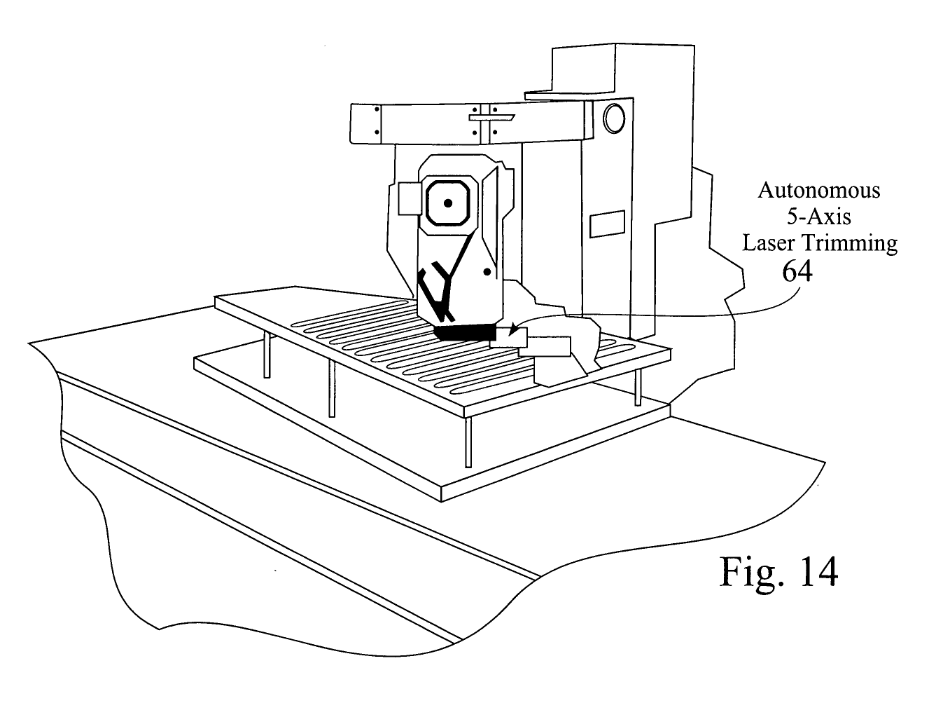

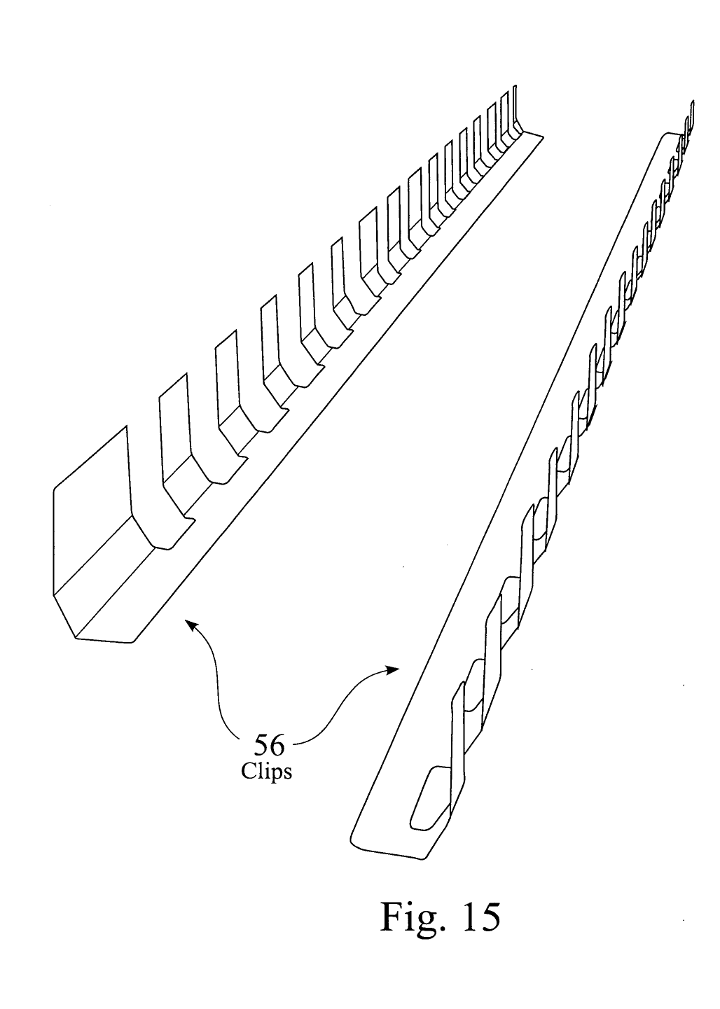

The manufacturing process for the radial bulkheads is as follows. Standard ANSI 301 stainless steel stock (Shown as 58 in FIG. 11) is sheared and laser trimmed to create a properly sized starting blank (Shown as 60 in FIG. 12). The blank is loaded into a punch and die stamping machine (FIG. 13) which forces the steel blank into a molded cavity, or die, under high pressure to form a radial bulkhead half (Shown as 62 FIG. 13). The part 62 is taken off the die and then inserted into a 5-axis laser trim station 64 which autonomously removes excess material and forms finished part features including drain holes and penetration (FIG. 14). The radial bulkhead clips 56 (FIG. 15) provide corner reinforcement and are manufactured in parallel using the same stainless steel, simple bend on brake forming, and laser trimming processes but on different tooling. Assembly of the final radial bulkhead component is performed by spot welding the two radial bulkheads of similar thickness, the two left radial bulkhead clips, and the two right radial bulkhead clips. The completed radial bulkhead assembly weighs about 11 pounds.

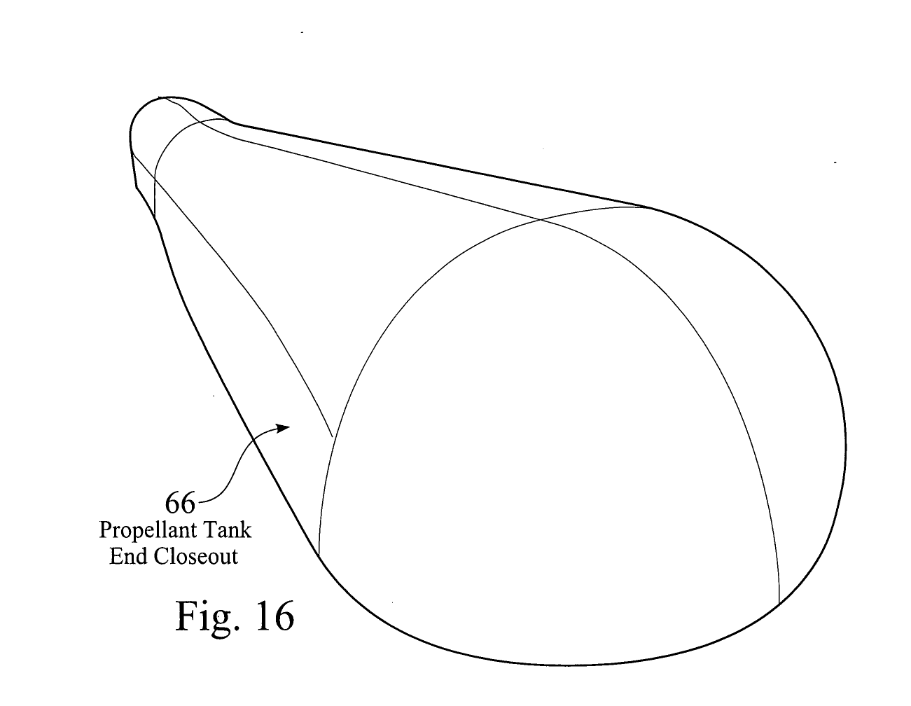

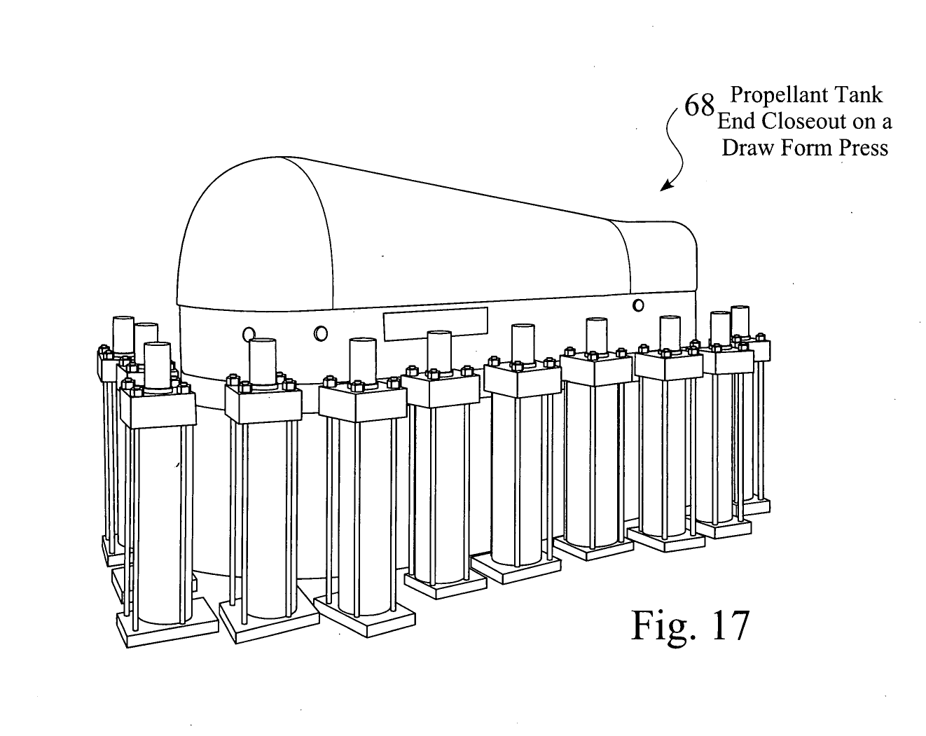

A large number of tank end closeouts are possible, and FIG. 16 depicts one of them 66 designed for a particular rocket propellant tank application. In contrast to typical aerospace rocket propellant tank manufacturing methods discussed prior such as forming a tank component from an isogrid skin panel by machining it from an aluminum alloy, this tank end closeout is manufactured using standard, commercial, non-aerospace industry, low-cost materials and methods. The manufacturing process for the tank end closeout is that of deep drawing, which is a compression-tension metal shaping process commonly used in automotive manufacturing. Standard ANSI 301 stainless steel stock (FIG. 11) is sheared and laser trimmed to create a properly sized starting sheet metal blank. The blank is loaded into a deep drawing press where it is mechanically drawn around a punch by a forming die. The edges of the sheet metal blank are held by a sleeve during the drawing process. In this particular case, one draw operation is not sufficient and the closeout is produced by two partial sequential deep drawing operations. FIG. 17 shows a propellant tank end closeout 68 on a draw form press after the second drawing operation. The part is taken off the die and then laser trimmed.

The tank skin is welded to the radial bulkheads to form a tank section. Multiple tank sections and tank closeouts, all formed from standard ANSI 301 stainless steel stock, are then welded together using standard, low cost resistance welding techniques to form a complete propellant tank.

Sample radial bulkheads and tank end closeouts have been manufactured by Michigan-based companies specializing in automotive parts prototyping using low cost materials, standard product forms, existing machinery, and mature, high rate manufacturing processes. Commercial automotive specialty manufacturers can produce all components for the propellant tanks and assemble, integrate, and test the tanks for a space launch vehicle for less than $15/lb, roughly the cost per pound of a luxury car, and at least an order of magnitude less than the cost of conventional rocket hardware. Out-sourcing the assembly, integration, and test of the complete propellant tanks to non-aerospace industry manufacturers eliminates almost all specialized manufacturing facilities, dramatically reducing facility and personnel fixed costs compared to a conventional aerospace manufacturing approach.

This example demonstrates that the approach of the present invention, of designing an aerospace system to be manufactured using commercial, low-cost, non-aerospace materials and manufacturing methods, allows primary aerospace components, such as rocket propellant tanks, to be fabricated for one to two orders of magnitude lower cost than by using standard aerospace materials and manufacturing methods. Another example of employing non-aerospace COTS components in an aerospace application as in the present invention is building a flight control computer for a space launch vehicle using non-aerospace COTS computer hardware rather than an aerospace industry manufactured flight control computer. A typical aerospace industry manufactured flight control computer is space-qualified and is very expensive due to very large development costs, expensive radiation-hardened components, extensive design effort to ensure it can function properly in extreme acceleration, acoustic, thermal, and radiation environments, and very low production economies of scale due to very limited demand. A single, expensive, highly customized, aerospace industry manufactured, flight control computer can be replaced by a very low cost, distributed network of multiple computers built using non-aerospace COTS components using standard protocols that are shielded from environmental stresses and networked to allow fail-safe operation in the advent of one or more individual computer failures. While not space-qualified to aerospace standards, when properly integrated and designed with fault tolerant network communication, this COTS-based system can be successfully applied to space launch. As with the example of the aerospace versus non-aerospace cryogenic valves, this approach vastly improves the number of vendors and COTS component economies of scale, greatly reducing costs and improving sustainability.

### CONCLUSION

Although the present invention has been described in detail with reference to one or more preferred embodiments, persons possessing ordinary skill in the art to which this invention pertains will appreciate that various modifications and enhancements may be made without departing from the spirit and scope of the Claims that follow. The various alternatives for providing an Aerospace Manufacturing System that have been disclosed above are intended to educate the reader about preferred embodiments of the invention, and are not intended to constrain the limits of the invention or the scope of Claims.

### LIST OF REFERENCE CHARACTERS

A Chart showing product content of typical conventional aerospace products
B Triangle representing aerospace products
C Custom designed components fabricated by aerospace industry manufacturing materials and processes
D Aerospace industry COTS components
E Custom designed components fabricated by non-aerospace industry manufacturing materials and processes
F Modified non-aerospace industry COTS components
G Unaltered non-aerospace industry COTS components
10 Chart showing product content of aerospace products using present invention
12 Triangle representing total aerospace product manufactured using present invention
14 Custom designed components fabricated by aerospace industry manufacturing materials and processes
16 Aerospace industry COTS components
18 Custom designed components fabricated by non-aerospace industry manufacturing materials and processes
20 Modified non-aerospace industry COTS components
22 Unaltered non-aerospace industry COTS components
24 Flowchart depicting typical current art for acquiring an aerospace component
26 Flowchart showing method for acquiring an aerospace component
28 Flowchart illustrating the method of iteratively optimizing the overall aerospace vehicle or product design
30 Rocket
32 Cut-away view of rocket
34 Fuel tank
36 Oxidizer tank
38 Rocket engine igniters
40 Rocket engine
42 Integrally stiffened skin panel
44 Isogrid pattern
46 Skin
48 Propellant tank body assembly
50 Tank skin
52 Radial bulkhead assembly
54 Exploded view of propellant tank body assembly
56 Clips
58 Stainless steel stock
60 Completed sheet metal blank
62 Completed part
64 Autonomous five-axis laser trimming
66 Propellant tank end closeout
68 Propellant tank end closeout on a draw form press

What is claimed is:

1. A method comprising the steps of:
reducing the manufacturing costs in an aerospace product; said aerospace product including a plurality of non-aerospace industry components; and
maximizing the use of said plurality of readily commercially available, non-aerospace industry components;
said plurality of readily commercially available, non-aerospace industry components including a commodity;
said commodity being commonly available;
said commodity being manufactured by a plurality of vendors; and
said plurality of vendors producing said commodity in accordance with commonly held performance standards.

2. A method comprising the steps of:
reducing fixed and recurring costs in manufacturing an aerospace product;
maximizing the use of a plurality of readily commercially available, non-aerospace industry manufactured components;
minimizing use of aerospace industry manufacturing;
designing said aerospace product by using as many of said plurality of readily commercially available, non-aerospace industry manufactured components as possible;
designing said aerospace product to use large quantities of readily commercially available, non-aerospace industry manufactured components to leverage high levels of economies of scale;
designing said aerospace product to use as many readily commercially available, non-aerospace components as possible;
designing said aerospace product to use alternate components designed to be manufactured by non-aerospace industry using conventional commercial, low-cost materials, manufacturing methods, and standards; and
by designing the aerospace product to use large quantities of said alternate components to leverage high levels of economies of scale.

3. A method as recited in claim 2, further comprising the step of:
out-sourcing the assembly, integration and testing of said aerospace product to a non-aerospace industry manufacturer to significantly reduce personnel and facility fixed costs.

4. A method as recited in claim 2, in which said plurality of readily commercially available, non-aerospace industry manufactured components are specifically designed to be able to use a low cost standardized transportation vehicle.

5. A method as recited in claim 4, in which said low cost standardized transportation vehicle is a standard containerized cargo enclosure.

6. A method as recited in claim 4, in which said low cost standardized transportation vehicle is a truck.

7. A method as recited in claim 4, in which said low cost standardized transportation vehicle is a ship.

8. A method as recited in claim 2, in which said plurality of readily commercially available, non-aerospace industry manufactured components have overall system reliability and sustainability of at least those produced by aerospace industry manufacturing.

9. A method as recited in claim 2, in which fixed and recurring costs incurred in manufacturing said aerospace product are reduced by at least thirty percent compared to conventional aerospace manufacturing.

10. A method as recited in claim 2, in which said aerospace product is used to provide low cost aerospace services.

11. A method as recited in claim 2, in which said aerospace product is a space launch vehicle.

12. A method as recited in claim 11, in which said space launch vehicle is used to provide low cost launch services.

13. A method as recited in claim 2, in which said aerospace product is a missile booster.

14. A method as recited in claim 2, in which said aerospace product is a missile system.
